(19) United States
(12) Patent Application Publication
(10) Pub. No.: US 2016/0024893 A1
(43) Pub. Date: Jan. 28, 2016

(54) APPLICATION PROGRAMMING INTERFACE TO PROBE RESERVOIR SIMULATION RESPONSE SURFACE MODELS

(71) Applicant: Saudi Arabian Oil Company, Dhahran (SA)

(72) Inventors: Ahmed S. Al-Zawawi, Dhahran (SA); Ali Ahmed Al-Taiban, Dhahran (SA); M. Ehtesham Hayder, Dhahran (SA)

(21) Appl. No.: 14/337,798

(22) Filed: Jul. 22, 2014

(51) Int. Cl. E21B 43/00; G06F 17/50

(52) U.S. Cl. CPC E21B 43/00; G06F 17/5009

(57) ABSTRACT

Embodiments of systems, non-transitory computer-readable medium having one or more computer programs stored therein, and computer-implemented methods are provided to enhance probing of hydrocarbon reservoir simulation models. Embodiments can utilize an application programming interface (API) to interrogate one or more different hydrocarbon reservoir simulation response surface model proxies (surface model proxies) associated with hydrocarbon reservoir simulation models. The API (a proxy API) can be configured to include preselected operations, and surface model proxies can be in a common image format. Surface model proxies can be interpreted to retrieve simulation data associated with the surface model proxies responsive to operations of the proxy API. Results of operations of the proxy API can also be displayed to probe a hydrocarbon reservoir simulation model associated with a surface model proxy and to thereby estimate probabilities of simulation outcome for potential simulation scenarios yet to be run.

### BACKGROUND OF THE INVENTION

1. Field of the Invention

Embodiments of the invention relate to hydrocarbon reservoir production and, more specifically to methods, systems, and non-transitory computer-readable medium having computer program stored therein to simulate fluid flow within hydrocarbon reservoirs.

2. Description of the Related Art

One or more hydrocarbon reservoir simulation models—digital models that reflect characteristics related to a reservoir's ability to store and produce hydrocarbons—may be used to simulate fluid flow within a hydrocarbon reservoir for a variety of reasons related to development and production of the hydrocarbon reservoir. For example, hydrocarbon reservoir simulation models may be used to run fluid flow simulations to predict residual oil saturations or recovery factors. Performing a simulation, sometimes called a simulation “study,” may include performing one or more simulation runs (sometimes called “cases”) on a hydrocarbon reservoir simulation model in furtherance of a preselected goal. A simulation study may include a collection of simulation runs with the same objective function (i.e., in view of the same goal). An entity may have one or more hydrocarbon reservoir simulation models of a given hydrocarbon reservoir, and, as a result, multiple studies may be performed with respect to a single hydrocarbon reservoir. Further, different types of simulations may be performed on hydrocarbon reservoir simulation models for specific, distinct purposes. For example, history-matching simulations may be performed. A history-matching simulation, for instance, may include running a simulation on a hydrocarbon reservoir simulation model associated with a hydrocarbon reservoir and comparing the simulation output to known, observed, or measured characteristic values associated with the hydrocarbon reservoir. After comparing the simulation output to known values, the hydrocarbon reservoir simulation model may be calibrated or fine-tuned to thereby improve its accuracy as a model of the hydrocarbon reservoir. A calibrated hydrocarbon reservoir simulation model may then be used to perform another type of simulation: a predictive simulation. A predictive simulation predicts future circumstances given a production strategy, for example. One type of a predictive simulation is an optimization simulation. Optimization simulations, for example, may serve to find one or more solutions to series of equations that maximize (or minimize, in some instances, as appropriate) the value of a mathematical function related to a preselected goal. Yet another type of simulation is an uncertainty simulation. Uncertainty simulations may include a set of simulation runs having various reservoir parameter values as inputs such that the uncertainty simulation covers a spectrum of possible or uncertain reservoir parameters. That is, input parameters may be varied within geological uncertainty ranges or within an error bound. Uncertainty simulations may be useful when exact values of reservoir parameters are not know. Both predictive and history-matching simulations may also be uncertainty simulations. In addition, risk simulations may be similar to uncertainty simulations but may focus more on the risk of an outcome or an objective of the simulation, e.g., oil plateau production for N years. Risk simulations may be predictive simulations.

History-matching simulations, optimization simulations, and uncertainty and risk simulations—sometimes called “case studies,” “simulation studies,” or “hydrocarbon reservoir simulation case studies”—may produce some result data after each run. The results from each simulation study may then be used to develop a hydrocarbon reservoir simulation response surface model proxy, which may be used to evaluate the outcome of different scenarios.

A hydrocarbon reservoir simulation response surface model proxy—sometimes called a “proxy,” a “proxy model,” a “response surface model,” a “response function,” a “response surface,” or a “reservoir simulation response surface model,” for example—may be generated based on the output of a simulation study. That is, a proxy may include a mathematical function related to a preselected goal of the associated simulation study (an “objective function” or a “simulation objective”) that approximates the relationship between inputs to and outputs of a simulation through a mathematical relationship or regression function, for example. More specifically, a proxy may be an approximating or correlating function. A proxy may capture the relationship between input to and output of a simulation. Further, the objective function of a simulation study may be the objective, i.e., the goal, of the study in terms of output. An objective function, for instance, may be to maximize oil production or recovery. Other examples of objective functions may include maximizing off take rate, rate plateau, cash flow, or net present value (NPV), or minimizing costs. Consequently, a proxy may be used to estimate simulation output given a set of input without actually having to run another simulation. For example, an entity may wish to be able to quickly provide results for scenarios not explicitly evaluated by the study through the use of proxies. Proxy output may be used, for example, to conserve computing resources or to save time. The value of the output of a proxy may thus be described as a “function estimated,” a “response surface value,” a “value of an objective function,” or a “value of an approximating function,” for example. Different proxies (approximating functions) may give different values of an objective function for a constant given set of input parameters, for instance. That is, a proxy may approximate the response of a hydrocarbon reservoir model for some reservoir model input and a stated objective function. Consequently, a proxy may correspond to a given hydrocarbon reservoir simulation model and to an objective function.

### SUMMARY OF THE INVENTION

Applicant has recognized many problems associated with proxies. For example, various techniques and technologies can be used during approximations, i.e., to generate each proxy. As a result, proxies can differ from one another depending, for example, on the algorithm used to approximate or correlate inputs to and outputs of a simulation.

For example, upstream activities in oil and gas industries can depend on integrated multidisciplinary teams to manage oil and gas fields and develop optimized field development plans (OFDP). Workflow processes to accelerate the delivery of OFDP are illustrated in FIG. 1A, for example. Reservoir engineers can develop multiple reservoir simulation studies under uncertainty 58 using one or more assisted history matching (AHM), optimization, or uncertainty and risk analysis packages. Each of these reservoir simulation studies can have its own response surface model (proxy) implementation. That is, each proxy can be generated using a different approach or technology. For instance, a particular software package for AHM, for example, can produce output in a format dissimilar to that of other approaches. These studies can also produce other simulation information, such as, for example: alternative field development strategies; alternative well tactics; alternative operational tactics; optimized field development plan (OFDP); objective functions of the study (net present value (NPV), plateau, cost, etc.); critical uncertainty factors (permeability, oil-water contact (OWC), etc.); simulation run results; and technical description and details.

In the process illustrated in FIG. 1A, for example, preparing 51 can include gathering and integrating information about an oil field to be studied, for example. Gathered information can include available previous study results, geological models, and historical information (e.g., rates, pressure, completions, work-overs, etc.). History matching 52 can then begin. That is, a simulation study can be constructed using the gathered data as input, for example. A history-matched model that results from this step can be associated with uncertainty 58 to account for unknown geological parameters, e.g., permeability, fractures, aquifers, etc. Uncertainty 58 related to reservoir properties can stem from unavailability or inadequacy of measurements or observations.

After concluding the history-match model 52, many comparison cases 53 can be constructed and studied. These comparison cases 53 can be reference prediction cases that are based on the history-matched model from the previous history-matching step 52. For example, comparison cases 53 can be predictive simulations to model fluid flow characteristics in a hydrocarbon field under the assumption that the field continues to be developed with no further work-over (such as pulling and replacing a completion) or without work-over development activities, as will be understood by those skilled in the art. Consequently, comparison cases 53 can be described as no-further-drilling cases. This step can produce many response surfaces because a response surface can be generated for each comparison case 53. Uncertainty 58 can exist in this step because uncertainty 58 can be inherited from the previous history-matching step 52. However, uncertainty 58 for comparison cases 53 can have narrowed ranges of parameters.

After developing comparison cases 53, a series of simulations can be performed to investigate the effects of one variable or uncertain input to a simulation while holding other inputs constant. Inputs to a simulation that can be uncertain can include, for example, static features of a hydrocarbon reservoir (e.g., structure, porosity, FWL, fractures, or NTG), dynamic features of a hydrocarbon reservoir (e.g., Kr's, PVT, skin factor, Swr, or Sor), prices (e.g., price of oil, gas, or NGLs), and timing (e.g., weather windows, approval process, or market availability), as will be understood by those skilled in the art. Variables inputs to a simulation can include development decisions to be made, including strategic planning, wells tactics, or operations tactics. For example, strategic analysis 54 can occur. Strategic analysis 54 can include running simulations related to a series of individual alternative development strategies—such as water injection, gas injection, and pattern water flood, for example—using the concluded history-matched model from the history-matching step 52, a single well tactic, and a single operation tactic for each alternative strategy. Well tactics can include, for example, choosing well location, well type, well spacing, well completion, or well tubing. Operations tactics, on the other hand, can include injection balance or ratio or bottom pressure, for example. To ensure that strategy is the only variable during strategic analysis 54, the same history-matched model, well tactic, and operation tactic can be applied in each of the strategy runs. This step 54 can produce many response surfaces because a response surface can be generated for each strategy that is analyzed. The outcome of this step 54 can be a preferred or optimized strategy resulting in an optimum objective function. Uncertainty 58 can exist in this step 54 because uncertainty 58 can be inherited from the previous steps. After concluding strategic analysis 54, well tactic analysis 55 can be performed. Well tactic analysis 55 can include running a series of simulations related to individual alternative well tactics—such as horizontal, vertical, multi-lateral, in-field, flank, or pattern, for example—using the optimized strategy from the strategic analysis step 54 and a single operation tactic. That is, strategy and operation tactic can be configured so as not to vary between respective well tactic runs. This step 55 can produce many response surfaces because a response surface can be generated for each well tactic that is analyzed. The outcome of this step 55 can be a preferred or optimized well tactic resulting in an optimum objective function. Uncertainty 58 can exist in this step 55 because uncertainty 58 can be inherited from the previous steps.

Then, during operation tactic analysis 56, a study related to a single operation tactic can be conducted to derive an optimal combination of alternative operation tactics, such as bottom hole flowing pressure or bottom hole injection pressure, for example. That is, alternative combinations of parameters (such as voidage replacement ratio or gas injection rates) can be varied to achieve a preselected objective. Optimization 59 can occur during operation tactic analysis 56 because operation tactics can be controlled, unlike geological parameters. Operation tactic analysis 56 can be conducted using the optimized development strategy and well tactic from the previous steps, and, as a result, operation tactic can be the only variable. The outcome of this step 56 can be a preferred or optimized operation tactic resulting in an optimum objective function.

The process can conclude with an optimized field development plan (OFDP) 57 using the optimal operation tactics, development strategy, and well tactic that resulted from previous steps. Uncertainty 58 can exist in this step 57 because uncertainty 58 can be inherited from the previous steps.

As a result, many proxies can be generated, and these proxies can be implemented by technology providers using different methodologies as part of scientific assisted history match, optimization, or uncertainty and risk assessment packages, for example. Despite having proxies generated using dissimilar approaches or technologies, an entity can nonetheless wish to have access to all generated proxies in one location. The task of providing access to all study decisions and results in an easy and intuitive manner, however, can be a major challenge for an entity with a large amount of hydrocarbon reservoir simulation data. Failing to provide such access, though, can contribute to many lost opportunities for the entity. For instance, the entity can fail to recognize a trend that is only apparent after analyzing multiple proxies.

In particular, some challenges in achieving this goal of providing access to all study decisions and results can include lack of standardization, utilization of many incompatible solutions and technologies, and large data size. In addition, problems, challenges, obstacles, or difficulties can include potential vendor lock-in, dependence on vendor-specific implementations for such an important reservoir management tool, and project delays because of dependence on vendors.

An entity can use an interface (a “dashboard”) to provide access to different proxy implementations—proxies generated by dissimilar approaches—for example. FIG. 1B can illustrate this workflow, for example, indicating the need for many custom links or adaptors specific to a particular technology implementation, such as a vendor-specific implementation. For example, access to proxies (response surface models) from a dashboard is illustrated in FIG. 1B. An integrated reservoir study 65, as illustrated in FIG. 1B, for example, can include use of a dashboard 66 and a simulation results database 67. The simulation results database 67 can include data related to: strategies, well tactics, operational tactics, and OFDP; objective functions (NPV, plateau, cost, etc.); critical uncertainty factors; simulation run results; technical description and recommendations; and other information, for example. The dashboard 66 can transmit SQL queries to the simulation results database 67 to thereby retrieve some of the information stored therein. Simulation run results stored in the simulation results database 67 can relate, for example, to a plurality of simulation studies, including simulation study 1 71, simulation study 2 72, and other simulation studies through simulation study N 73. Each simulation study can have an associated proxy model. That is, simulation study 1 71 can have an associated proxy model 1 74, and simulation study 2 72 can have an associated proxy model 2 75. Proxy model 1 74 and proxy model 2 75 can each have been generated by technology 1 68, for example. Further, simulation study N 73 can have an associated proxy model N 76. In contrast to proxy model 1 74 and proxy model 2 75, proxy model N 76 can have been generated by technology M 69. To retrieve information related to a proxy model, the dashboard 66 can be required to query a custom adaptor associated with each technology. For example, technology 1 68 can have an associated custom adaptor 1 77, and technology M 69 can have an associated custom adaptor N 78. Further, custom links can also be used, for example, to provide access to proxies from a dashboard though multiple custom links. Examples of some challenges, however, can include: unwillingness of technology providers (vendors) to share internal proprietary implementation specifications with a managing entity, competing vendors working on other parts of a dashboard, the complexity, and resources required to support all required proxy implementations, for example.

Applicant has recognized that a dashboard that requires customization to enable probing of hydrocarbon reservoir simulation response surface model proxies generated by dissimilar approaches or technologies can be difficult to create and maintain. As a result, Applicant hereby discloses embodiments of the present invention that can eliminate a need for customization to each technology used to create a hydrocarbon reservoir simulation response surface model proxy. Advantageously, embodiments can thus eliminate any potential vendor lock-in or dependence on vendor-specific implementations by eliminating the need for high-overhead, complex links required to integrate a dashboard with different vendor proxy (response surface models) implementations. In addition, any need to continually revise a developed dashboard whenever a vendor implementation is updated or changed can be eliminated. Furthermore, embodiments can accelerate project delivery by eliminating many possible project show-stoppers, including vendor resistance to sharing underling implementation details required to develop custom links, and can allow all project participants to focus on their expertise.

More specifically, an application programming interface (API) can be developed to overcome some of the limitations described above. An API can be used to probe a response function (proxy) and get the response surface value (i.e., function estimated value) with certain (i.e., specific) probabilities of the response surface value's being accurate. Further, a response surface value can be obtained under different, uncertain conditions. For example, embodiments of the invention—including, for example, API design—can make a dashboard interoperable with various reservoir simulation proxies (response surface models) developed using diverse technological frameworks, i.e., using different technologies. An R-language framework, for example, can make it easy to implement statistical analysis functions. That is, routines defined in an API according to embodiments of the invention—a “proxy API,” for example—can be implemented in a programming language and environment for statistical computations, such as that provided by R language. R language, as will be understood by those skilled in the art, is designed for efficient statistical computations and data mining operations. The proxy API specification in R image format can provide interoperability of a dashboard with technologies used in various simulation proxies. For instance, exported R images files can then be loaded into an R interpreter, which can be connected to a dashboard. The dashboard can communicate with the R interpreter through the set of function calls specified in the proxy API and implemented in the R images files loaded into the R interpreter.

Embodiments of the invention can include systems, computer-implemented methods, and non-transitory computer-readable medium having computer program stored therein to enhance probing of hydrocarbon reservoir simulation models. For example, a system to enhance probing of hydrocarbon reservoir simulation models, according to an embodiment, can include one or more processors and one or more databases in communication with the one or more processors. The one or more databases can also have data associated with one or more different hydrocarbon reservoir simulation response surface model proxies stored therein. For example, data associated with the one or more different hydrocarbon reservoir simulation response surface model proxies can include the one or more different hydrocarbon reservoir simulation response surface model proxies themselves, as well as hydrocarbon reservoir simulation study results. Further, the one or more different hydrocarbon reservoir simulation response surface model proxies can thereby define surface model proxies. The surface model proxies can have a common image format based on a conversion from a plurality of different simulation model technology formats to the common image format. In addition, each of the surface model proxies can be associated with one of one or more hydrocarbon reservoir simulation models. A system can also include one or more input and output units in communication with the one or more processors and positioned to receive input and output communication. In addition, a system can include a display in communication with the one or more processors. The display can be configured to display an electronic user interface thereon, for example. A system can still further include non-transitory memory medium in communication with one or more of the one or more processors. The memory medium can have computer-readable instructions stored therein that when executed cause the one or more processors to perform a series of steps.

The steps can include, for example, initiating a proxy application programming interface (API), responsive to user request through the one or more input and output units. Initiating the proxy API can thereby interrogate one or more of the surface model proxies from the one or more databases. In addition, the proxy API can be configured to include a plurality of different preselected operations. The steps can also include interpreting each of the one or more of the surface model proxies. Interpreting each of the one or more of the surface model proxies can thereby retrieve a simulation data set for each of the one or more surface model proxies responsive to each of the plurality of different preselected operations of the proxy API. The steps can further include displaying—for each of the one or more surface model proxies—one or more results of each of the plurality of different preselected operations of the proxy API through the electronic user interface on the display to thereby probe the associated hydrocarbon reservoir simulation models. In some circumstances, displaying can include selectively displaying one or more uncertainty characteristics of each of the one or more of the surface model proxies on the electronic user interface by use of the proxy API. The one or more uncertainty characteristics can be configured to include an S-curve related to each of the surface model proxies, for example. Further, each of the one or more S-curves can depict cumulative probabilities of simulation outcome data. S-curves can be analyzed to estimate one or more probabilities of simulation outcome for one or more potential simulation scenarios yet to be run. Estimating probabilities of simulation outcome can thereby enhance probing of the one or more hydrocarbon reservoir simulation models. Additionally, one or more of the plurality of different preselected operations of the proxy API can responsively enhance one or more workflows for hydrocarbon field development plans.

Embodiments can also include computer-implemented methods to enhance probing of hydrocarbon reservoir simulation models. For example, a computer-implemented method can include initiating a proxy application programming interface (API) to thereby interrogate one or more of one or more different hydrocarbon reservoir simulation response surface model proxies. The one or more different hydrocarbon reservoir simulation response surface model proxies can thereby define surface model proxies. Furthermore, the surface model proxies can have a common image format based on a conversion from a plurality of different simulation model technology formats to the common image format. Each of the surface model proxies can be associated with one of one or more hydrocarbon reservoir simulation models, for example. In addition, the proxy API can be configured to include a plurality of different preselected operations. A method can also include interpreting each of the one or more of the surface model proxies to thereby retrieve a simulation data set for each of the one or more of the surface model proxies responsive to each of the plurality of different preselected operations of the proxy API. Further, a method can include displaying, for each of the one or more of the surface model proxies, one or more results of each of the plurality of different preselected operations of the proxy API to thereby probe the associated hydrocarbon reservoir simulation models. In some circumstances, displaying can include selectively displaying one or more uncertainty characteristics of each of the one or more of the surface model proxies by use of the proxy API. The one or more uncertainty characteristics can be configured to include an S-curve related to each of the surface model proxies. Further, each of the one or more S-curves can depict cumulative probabilities of simulation outcome data. S-curves can be analyzed to estimate one or more probabilities of simulation outcome for one or more potential simulation scenarios yet to be run. Estimating probabilities of simulation outcome can thereby enhance probing of the one or more hydrocarbon reservoir simulation models. Additionally, one or more of the plurality of different preselected operations of the proxy API can responsively enhance one or more workflows for hydrocarbon field development plans.

Embodiments can still further include non-transitory computer-readable medium having one or more computer programs stored therein operable by one or more processors to enhance probing of hydrocarbon reservoir simulation models. For example, in non-transitory computer-readable medium having one or more computer programs stored therein operable by one or more processors according to an embodiment, the one or more computer programs can include a set of instructions that, when executed by the one or more processors, cause the one or more processors to perform a series of operations. The operations that the one or more processors perform can include, for example, initiating a proxy application programming interface (API) to thereby interrogate one or more of one or more different hydrocarbon reservoir simulation response surface model proxies. The one or more different hydrocarbon reservoir simulation response surface model proxies can thereby define surface model proxies, for example. Further, the surface model proxies can have a common image format based on a conversion from a plurality of different simulation model technology formats to the common image format. Each of the surface model proxies can be associated with one of one or more hydrocarbon reservoir simulation models. In addition, the proxy API can be configured to include a plurality of different preselected operations. The operations that the one or more processors perform can also include, for example, interpreting each of the one or more of the surface model proxies to thereby retrieve a simulation data set for each of the one or more of the surface model proxies responsive to each of the plurality of different preselected operations of the proxy API. The operations that the one or more processors perform can further include displaying, for each of the one or more of the surface model proxies, one or more results of each of the plurality of different preselected operations of the proxy API to thereby probe the associated hydrocarbon reservoir simulation models. In some circumstances, displaying can include selectively displaying one or more uncertainty characteristics of each of the surface model proxies by use of the proxy API. The one or more uncertainty characteristics can be configured to include an S-curve related to each of the surface model proxies. Further, each of the one or more S-curves can depict cumulative probabilities of simulation outcome data. S-curves can be analyzed to estimate one or more probabilities of simulation outcome for one or more potential simulation scenarios yet to be run. Estimating probabilities of simulation outcome can thereby enhance probing of the one or more hydrocarbon reservoir simulation models. Additionally, one or more of the plurality of different preselected operations of the proxy API can responsively enhance one or more workflows for hydrocarbon field development plans.

### BRIEF DESCRIPTION OF THE DRAWINGS

These and other features, aspects, and advantages of the present invention will become better understood with regard to the following descriptions, claims, and accompanying drawings. It is to be noted, however, that the drawings illustrate only several embodiments of the invention and are therefore not to be considered limiting of the invention's scope as it can admit to other equally effective embodiments.

FIG. 1A is a schematic diagram of a method according to an embodiment of the invention.

FIG. 1B is a schematic diagram of a system according to an embodiment of the invention.

FIG. 2 is a schematic diagram of a system according to an embodiment of the invention.

FIG. 3 is a schematic diagram of a system according to an embodiment of the invention.

FIG. 4 is a schematic user interface according to an embodiment of the invention.

FIG. 5 is a schematic diagram of a system according to an embodiment of the invention.

FIG. 6 is a schematic diagram of a system according to an embodiment of the invention.

FIG. 7 is a schematic diagram of a method according to an embodiment of the invention.

FIG. 8 is a schematic diagram of a method according to an embodiment of the invention.

FIG. 9 is a schematic diagram of a method according to an embodiment of the invention.

FIG. 10 is a table of operations of an application programming interface according to an embodiment of the invention.

FIG. 11 is a table of operations of an application programming interface according to an embodiment of the invention.

FIG. 12 is a table of data related to simulation runs according to an embodiment of the invention.

FIG. 13 is a schematic diagram of an S-curve of the data in the table in FIG. 12 according to an embodiment of the invention.

### DETAILED DESCRIPTION OF THE INVENTION

So that the manner in which the features and advantages of the embodiments of methods, systems, and non-transitory computer-readable medium having computer program stored therein of the present invention, as well as others, which will become apparent, may be understood in more detail, a more particular description of the embodiments of methods, systems, and non-transitory computer-readable medium having computer program stored therein of the present invention briefly summarized above may be had by reference to the embodiments thereof, which are illustrated in the appended drawings, which form a part of this specification. It is to be noted, however, that the drawings illustrate only various embodiments of the embodiments of methods, systems, and non-transitory computer-readable medium having computer program stored therein of the present invention and are therefore not to be considered limiting of the embodiments of methods, systems, and non-transitory computer-readable medium having computer program stored therein of the present invention's scope as it may include other effective embodiments as well.

Embodiments of the invention can include systems, computer-implemented methods, and non-transitory computer-readable medium having computer program stored therein to enhance probing of hydrocarbon reservoir simulation models. More specifically, embodiments of the invention can include an application programming interface that provides an interface to probe reservoir simulation response surface models (proxies). Embodiments can enable probing of hydrocarbon reservoir simulation response surface model proxies—sometimes called “proxies,” “proxy models,” “response surface models,” “response functions,” “response surfaces,” or “reservoir simulation response surface models,” for example—by use of an application programming interface (API) and a user interface, e.g., a “dashboard,” to display uncertainty and risk information. A need for an API according to an embodiment of the invention—a “proxy API,” for example—can exist in implementing workflows using response surfaces for statistical analysis. A proxy API can also be used for any other project that would need to probe reservoir simulation proxies to estimate uncertainty or risk parameters, however. Advantageously, embodiments can include simplifying development and integration of complex applications and dashboards that extract uncertainty and risk information from various response surface models (proxies).

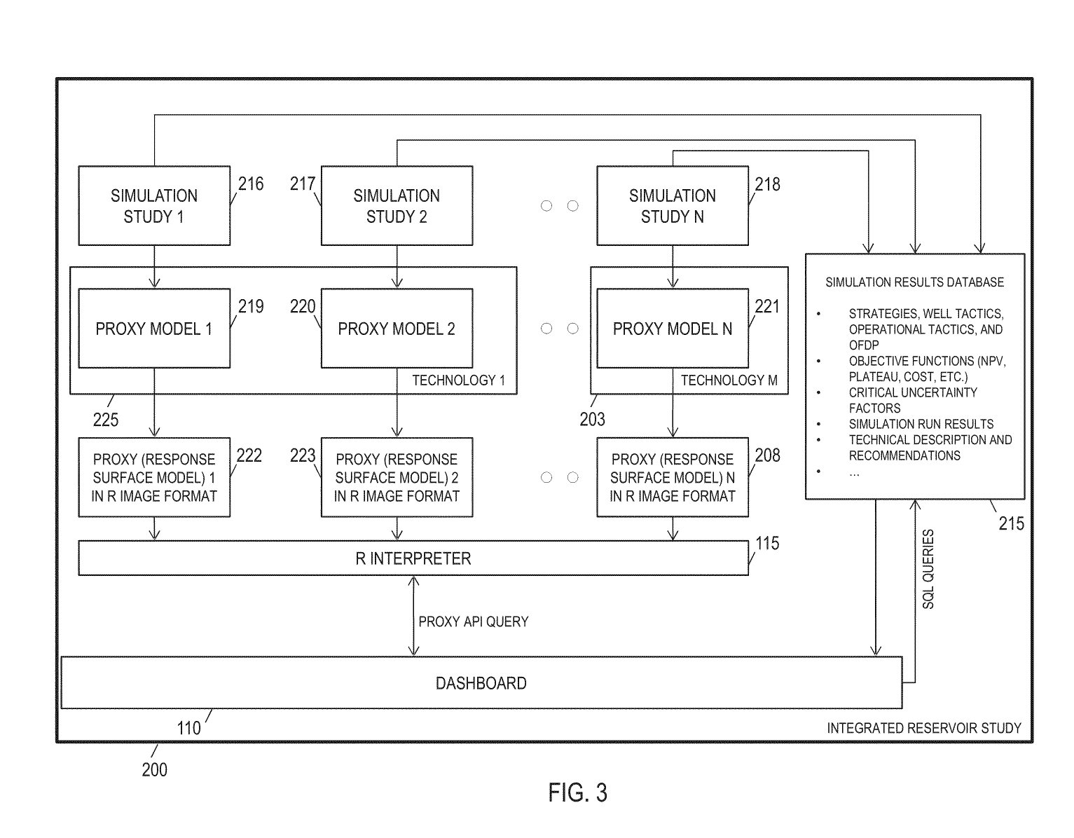

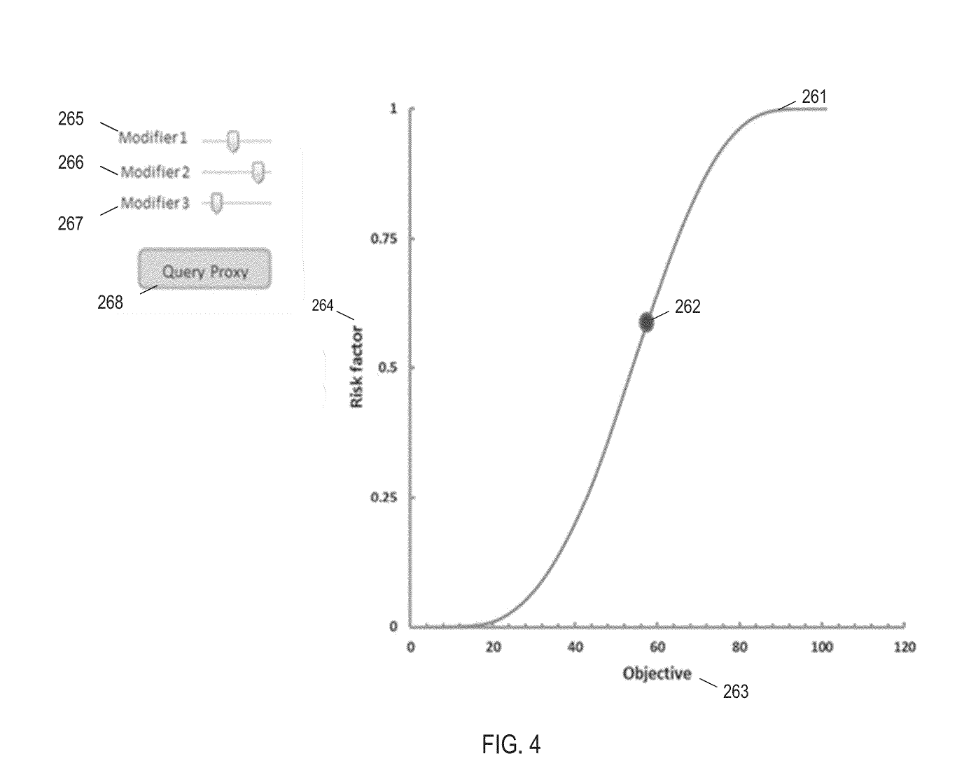

A proxy API can be designed to help interrogate hydrocarbon reservoir simulation proxies (response surface models). Notably, these proxies can be generated using dissimilar approaches or technologies. A proxy API can advantageously be designed to provide a common interface and to hide underlying implementation details, e.g., details associated with an individual proxy-creation technology. Further, a proxy API can be used to build workflows to estimate probabilities of simulation outcome, such as probabilities of simulation outcome associated with achieving an objective function of a simulation study, for scenarios that were not run but fall between completed runs. For example, workflows built can include workflows built with a proxy API in business intelligence tools, as will be understood by those skilled in the art, such as a workflow related to the system depicted in FIG. 3 or the user interface depicted in FIG. 4, for example. A proxy API can also provide functionalities to identify simulation models with close realization bracketing given a set of simulation parameters.

More specifically, a proxy API according to an embodiment of the invention can be designed to probe hydrocarbon reservoir simulation proxies or response surface models. A proxy API can be a gateway that allows development and integration of complex applications and dashboards to analyze uncertainty and risk information extracted from proxies or response surface models. These proxies can be generated using dissimilar approaches. Further, a proxy API can be developed in an R language environment for statistical computing. The R language environment can allow quick access to various statistical parameters from proxies, for example. A proxy API can also be designed to provide a common interface and hide underlying proxy details from complex application developers. Moreover, a proxy API according to an embodiment can provide functionalities to access uncertainty characteristics observed in a set of reservoir simulations and can be used to build workflows to estimate probabilities of simulation outcome (such as probabilities of simulation outcome associated with achieving a certain objective function) for scenarios that were not run but can fall between completed runs or, in some circumstances, for example, completed studies. An API can further provide functionalities to identify simulation models with close realization bracketing given a set of parameters. Close realization can refer to hydrocarbon reservoir models that have reservoir parameter values that are close to one another, for example. Further, bracketing can indicate being within some tolerance limit. Consequently, close realization bracketing can describe models that have variations in parameters within some limit (a “bracket”) from a scenario under investigation.

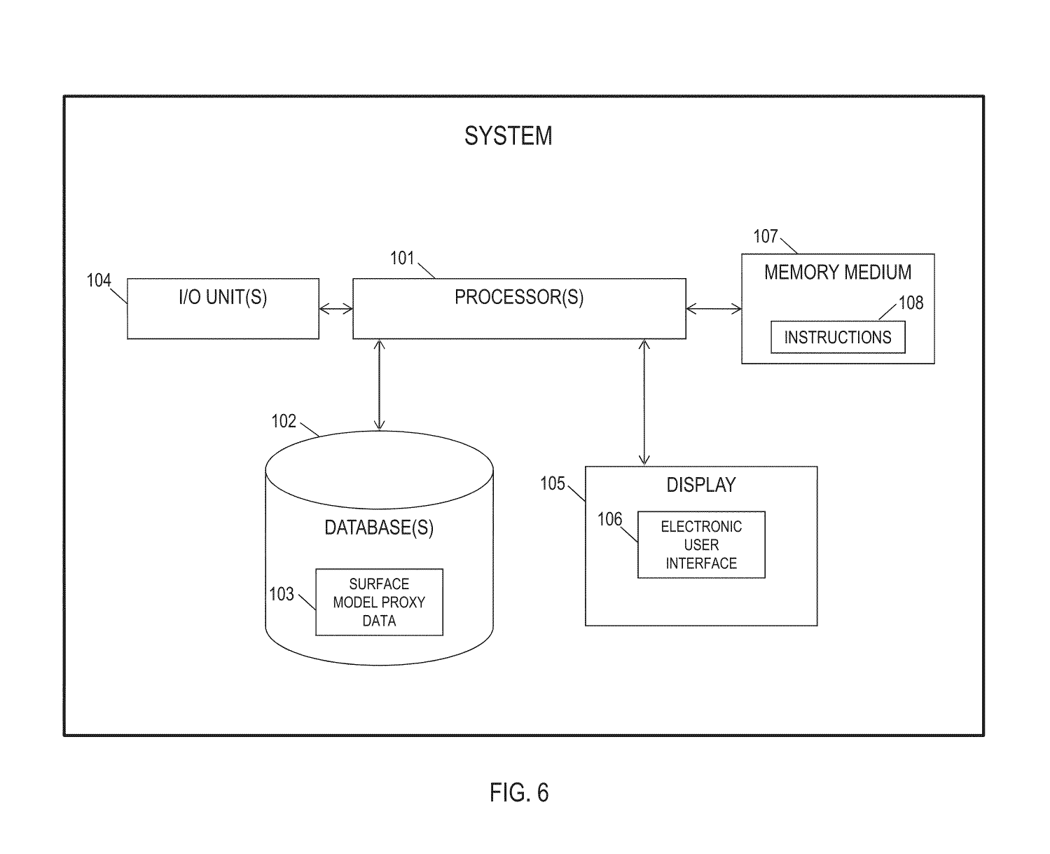

For example, a system to enhance probing of hydrocarbon reservoir simulation models, according to an embodiment, can include one or more processors 101 and one or more databases 102 in communication with the one or more processors 101, as illustrated in FIG. 6, for example. A hydrocarbon reservoir simulation model, as will be understood by those skilled in the art, can include a simulated model of one or more hydrocarbon reservoirs configured to be used to simulate fluid flow or other hydrocarbon reservoir characteristics, for example. The one or more databases 102 can also have data 103 associated with one or more different hydrocarbon reservoir simulation response surface model proxies stored therein. For example, data 103 associated with the one or more different hydrocarbon reservoir simulation response surface model proxies can include the one or more different hydrocarbon reservoir simulation response surface model proxies as well as hydrocarbon reservoir simulation study results. The one or more different hydrocarbon reservoir simulation response surface model proxies can thereby define surface model proxies. Each of the surface model proxies can be associated with one of one or more hydrocarbon reservoir simulation models. Additionally, the surface model proxies can have a common image format based on a conversion from a plurality of different simulation model technology formats to the common image format. Further, hydrocarbon reservoir simulation study results can relate to output of one or more hydrocarbon reservoir simulation runs. An example can relate to hydrocarbon production plateau duration. Hydrocarbon production plateau duration, as will be understood by those skilled in the art, can relate to the number of years before a hydrocarbon reservoir loses its ability to constantly deliver a hydrocarbon production target. A number of simulation runs can be performed to predict plateau duration, and the results of the simulation runs can then be used to develop a surface model proxy, for example, that approximates the relationship between inputs to the simulation runs and the resulting predicted plateau duration.

A system can also include one or more input and output units 104 in communication with the one or more processors 101 and positioned to receive input and output communication. Further, a system can include a display 105 in communication with the one or more processors 101. The display 105 can be configured to display an electronic user interface 106 thereon, as will be understood by those skilled in the art, for example. A system can still further include non-transitory memory medium 107 in communication with one or more of the one or more processors 101. The memory medium 107 can have computer-readable instructions 108 stored therein that when executed cause the one or more processors 101 to perform a series of steps. The steps can include, for example, initiating a proxy application programming interface (API), responsive to user request through the one or more input and output units 104, to thereby interrogate one or more of the surface model proxies from the one or more databases 102. Interrogating (or “probing”) one of the surface model proxies can include, for example, obtaining associated risk and uncertainty information or an output value of the one of the surface model proxies given a set of hydrocarbon reservoir simulation run parameters. The proxy API can be configured to include a plurality of different preselected operations, for example. The steps can also include interpreting each of the one or more of the surface model proxies to thereby retrieve a simulation data set for each of the one or more of the surface model proxies responsive to each of the plurality of different preselected operations of the proxy API. Each simulation data set can include, for example, one or more uncertainty characteristics associated with one or more hydrocarbon reservoirs. Uncertainty characteristics can relate to uncertainty about properties of a real hydrocarbon reservoir and can accordingly relate to uncertainty in hydrocarbon models or proxies stemming from uncertainty related to an associated real reservoir. Uncertainty characteristics, for example, can relate to cumulative probability. The steps can further include displaying through the electronic user interface 106 on the display 105—for each of the one or more of the surface model proxies—one or more results of each of the plurality of different preselected operations of the proxy API to thereby probe the associated hydrocarbon reservoir simulation models. In some circumstances, displaying can include selectively displaying one or more uncertainty characteristics of each of the one or more of the surface model proxies on the electronic user interface 106 by use of the proxy API. The one or more uncertainty characteristics, for example, can be configured to include an S-curve related to each of the surface model proxies. Additionally, each of the one or more S-curves can depict cumulative probabilities of simulation outcome data.

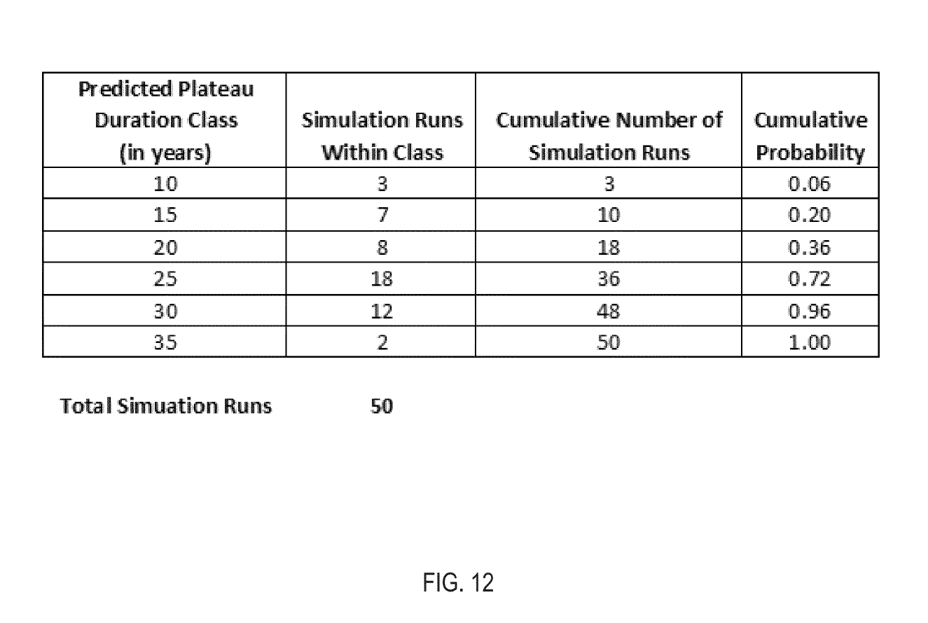

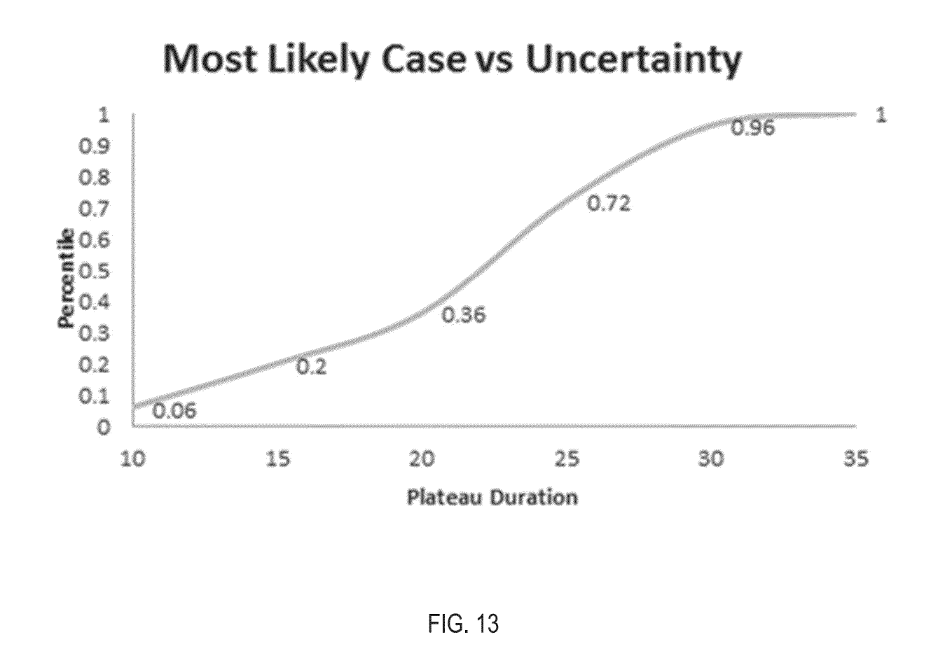

As noted above, an example can relate to hydrocarbon production plateau duration. Hydrocarbon production plateau duration, as will be understood by those skilled in the art, can relate to the number of years before a hydrocarbon reservoir loses its ability to constantly deliver a hydrocarbon production target. A number of simulation runs can be performed to predict plateau duration, and the results of the simulation runs can be grouped into classes of output. For example, the predicted plateau duration for each simulation run can be grouped into one of the following classes: 10 years, 15 years, 20 years, 25 years, 30 years, or 35 years, as illustrated in the table in FIG. 12, for example. The groups can thus represent a discrete approximation of the results of the simulation runs. A continuous representation of the approximation can be generated, however, by plotting the percentage of the simulation runs that predicted a given plateau duration or a shorter plateau duration as a function of plateau duration, as depicted in FIG. 13, for example. The resulting curve can be described as an S-curve, for instance, that represents cumulative probability information. Each completed simulation run can consequently correspond to a data point used to build the S-curve. Further, an exemplary optimization study to maximize oil production plateau (i.e., the number of years before a hydrocarbon reservoir is unable to deliver a constant production target) can have four parameters of uncertain value and one design parameter. The parameters of uncertain value can be varied between simulation runs because they can represent actual properties of the real hydrocarbon reservoir (i.e., the real hydrocarbon reservoir being modeled) that are not known with certainty. For example, parameters of uncertain value can include permeability_x, permeability_y, permeability_z, and fault locations. Design parameters, on the other hand, can include possible approaches to developing the hydrocarbon reservoir that are within the control of the developing entity, e.g., well type. Each set of input parameters can produce a particular output of a simulation run of the hydrocarbon reservoir simulation model, but two or more sets of input parameters can—in some circumstances—produce the same output. In this example, by dividing the range of variation of the uncertain parameters into eight intervals each, there are 8⁴, or 4,096, combinations of parameters or sets of data. If three values of design parameters are examined (e.g., three well types are tested), the number of simulations needed to cover the whole spectrum of possibilities is 4,096 multiplied by 3, or 122,288, runs. Proxy techniques can advantageously reduce the required number of simulation runs to approximately 100 runs by building a response surface, or correlation, of output to input parameters. The proxy API can allow interrogation of a response surface or proxy and estimation of the simulation output without actually performing additional simulation runs. In this example, the objective function is to maximize the oil production plateau. Further, probabilities of simulation outcome in the example are likelihoods of simulation output (proxy estimates) given uncertainties in four parameters in the study.

In some circumstances, the one or more uncertainty characteristics can include a proxy value responsive to a set of most likely hydrocarbon reservoir simulation run parameters from the one or more input and output units 104. Most likely hydrocarbon reservoir simulation run parameters can include, for example, hydrocarbon reservoir simulation run parameters (“parameters” or “modifiers”) selected by a user. In some instances, modifiers can be parameters that are varied during a simulation run (i.e., input to the simulation run) to get a whole spectrum of solutions within an uncertainty range. For example, permeability_x for a region may be varied by a multiplication factor X₁ to get a set of runs; in that example, X₁ can be a modifier. A user can select parameters related to a hydrocarbon reservoir simulation run that has not yet been performed when, for instance, the user would like an approximated simulation outcome, given a set of parameters, without having to devote resources to an additional hydrocarbon reservoir simulation run. Further, a proxy value can include the value of an approximating function of the hydrocarbon reservoir simulation response surface model proxy given a set of hydrocarbon reservoir simulation run parameters. A set of most likely hydrocarbon reservoir simulation run parameters can be one of one or more possible sets of hydrocarbon reservoir simulation run parameters, for example.

Further, one or more of the plurality of different preselected operations of the proxy API can responsively enhance one or more workflows for hydrocarbon field development plans. In some instances, one or more third-party tools can implement the one or more workflows for hydrocarbon reservoir field development plans. The proxy API can advantageously allow better performing workflows for hydrocarbon reservoir field development plans because the proxy API can transcend different kinds of proxies, for example, such as those created by different approaches or technologies. An example of one of the plurality of different preselected operations of the proxy API that can responsively enhance one or more workflows for hydrocarbon field development plans can include, for instance, accessing uncertainty characteristics observed in a set of reservoir simulations. Further, use of the proxy API can enhance interactivity of a tool to build or implement such workflows in a more efficient manner.

The plurality of different preselected operations of the proxy API can include, for example, determining—responsive to a first preselected simulation objective—an output value of one or more of the surface model proxies for a first preselected set of hydrocarbon reservoir simulation run parameters with respect to the surface model proxies to thereby query the one or more of the surface model proxies. In addition, the plurality of different preselected operations of the proxy API can include, for example, identifying—responsive to a second preselected simulation objective—one of the hydrocarbon reservoir simulation models associated with one of the surface model proxies when the one of the surface model proxies has an output value for a second preselected set of hydrocarbon reservoir simulation run parameters with respect to the surface model proxies that is closest to output values of a preselected simulation scenario. The identified hydrocarbon reservoir simulation model can thereby define a closest model.

Further, the plurality of different preselected operations of the proxy API can include, for example, identifying—responsive to a third preselected simulation objective—two of the hydrocarbon reservoir simulation models each associated with one of the surface model proxies and thereby defining close realization bracketing models. For example, the two models can be identified when: (1) one of the two of the surface model proxies has an output value for a third preselected set of hydrocarbon reservoir simulation run parameters with respect to the surface model proxies that is closest to the output value of another preselected simulated scenario among output values higher than the output value of the other preselected simulated scenario and (2) the other of the two of the surface model proxies has an output value for the third preselected set of hydrocarbon reservoir simulation run parameters that is closest to the output value of the other preselected simulated scenario among output values lower than the output value of the other preselected simulated scenario. That is, at least one of the plurality of different preselected operations of the proxy API can include identifying one or more of the surface model proxies that have close realization bracketing for a preselected set of hydrocarbon reservoir simulation run parameters with respect to the surface model proxies, for example. Close realization bracketing can include, for example, two of the surface model proxies that—given the preselected set of hydrocarbon reservoir simulation run parameters—have associated proxy values that are nearest to a proxy value associated with a hydrocarbon reservoir simulation response surface model proxy under interrogation. More specifically, one of the two of the surface model proxies can have an associated proxy value that is greater than the proxy value of the proxy under interrogation, and the other of the two of the surface model proxies can have an associated proxy value that is less than the proxy value of the proxy under interrogation. The two of the surface model proxies can thus “bracket” the proxy under interrogation. One of the close realization bracketing models can also be the closest model. Further, the preselected set of hydrocarbon reservoir simulation run parameters can be a different set of hydrocarbon reservoir simulation run parameters than the set of most likely hydrocarbon reservoir simulation run parameters, in some circumstances, or the preselected set of hydrocarbon reservoir simulation run parameters can be the same set of hydrocarbon reservoir simulation run parameters as the set of most likely hydrocarbon reservoir simulation run parameters.

In addition, the plurality of different preselected operations of the proxy API can include, for example, identifying names of one or more hydrocarbon reservoir simulation run parameters with respect to the surface model proxies responsive to a fourth preselected simulation objective to thereby return the identified one or more hydrocarbon reservoir simulation run parameters. The first, second, third, and fourth preselected simulation objectives can be the same simulation objective, in some circumstances, but each of the preselected simulation objectives can also be different from one or more of the other preselected simulation objectives.

Further, in some circumstances, the steps can also include displaying on the display 105—by use of the proxy API—observed reservoir characteristic values for one or more of the one or more hydrocarbon reservoirs to a user, for example. For instance, observed reservoir characteristic values can include measured data related to a hydrocarbon reservoir. Further, in some instances, input to a hydrocarbon reservoir simulation model used to create a proxy can have included these displayed observed reservoir characteristic values. Observed reservoir characteristic values can be stored in one or more databases, for example, including one or more of the one or more databases 102. For example, observed reservoir characteristic values can be stored in a simulation results database 215, as illustrated in FIG. 3, for example.

In some circumstances, each of the plurality of different simulation model technology formats can be associated with a unique set of one or more algorithms used to create a hydrocarbon reservoir simulation response surface model proxy. Each of the plurality of different simulation model technology formats can also be associated with a unique technology vendor, in some instances. Further, each of the one or more of the surface model proxies can be configured to simulate performance for a respective preselected period of desired time. For instance, an assisted history matching study can be performed using different technology than an optimization study. As a result, output of each study can be in a different format, for example, and interrogating proxies of each study can require different techniques. Further, proxies generated by dissimilar technology can measure or represent uncertainty or risk differently. Additionally, in some instances, one or more of the surface model proxies can each be generated responsive to one or more hydrocarbon reservoir simulation study approaches dissimilar from a hydrocarbon reservoir simulation study approach used to generate another one or more of the surface model proxies. Hydrocarbon reservoir simulation study approaches dissimilar from one another can include an assisted history matching study, a predictive study, an optimization study, and an uncertainty and risk analysis study, for example. As a result, different S-curves can correspond to different proxy technologies (i.e., approximating functions or implementations) or realizations of a hydrocarbon reservoir. Further, different realizations of a hydrocarbon reservoir can correspond to different sets of reservoir parameters that are all within an acceptable range of uncertainty of knowledge of the hydrocarbon reservoir. There can be an enormous number of unknown parameters in a hydrocarbon reservoir and sometimes only a very limited number of measurements or logs to determine these parameters, which can be a source of uncertainty in a reservoir model. One S-curve can correspond to a set of simulation runs when values of input parameters (modifiers) are changed. Further, a given set of values of modifiers can correspond to a point on the S-curve.

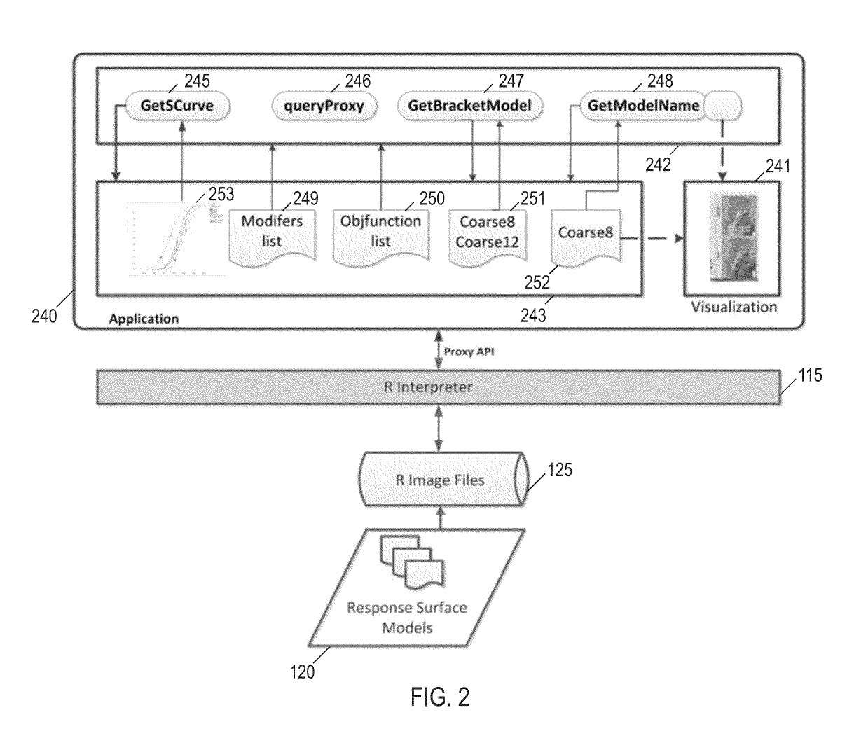

A proxy API can be built using a robust and popular framework for statistical analysis, e.g., R language, which can make it portable. Further, API routines (functions) can be carefully designed for hydrocarbon reservoir management analysis/decisions and dashboard implementation. That is, in some circumstances, the proxy API can relate to a system environment for statistical computing that includes R programming language, as will be understood by those skilled in the art. The common image format can include R image format, as well, which can be compatible with a plurality of technologies and approaches. Furthermore, interpreting each of the one or more of the surface model proxies can include translating one or more R image files associated with each of the one or more of the surface model proxies into a format readable by the proxy API. Translating the one or more R image files can thereby retrieve predetermined data from the one or more of the surface model proxies responsive to user request. As a result, an R interpreter 115 can be used, as illustrated in FIG. 2, for instance. FIG. 2 illustrates a workflow designed using proxy API routines and depicts the interaction of an application 240 with R image files 125 using proxy API routines, for example. That is, unconverted response surface models 120 can be exported to R image files 125, for instance, where the R image format is the common image format. An application 240 can then be used to interrogate the response surface models 120 (in R image format as R image files 125) by use of the proxy API and the R interpreter 115.

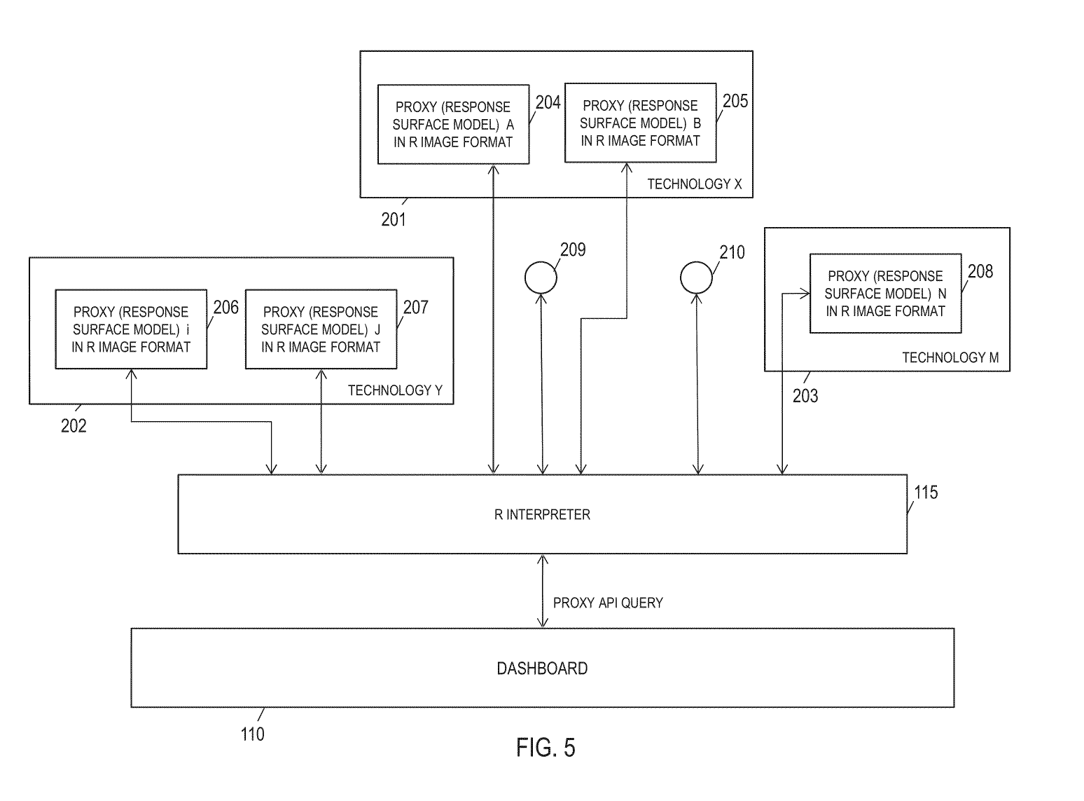

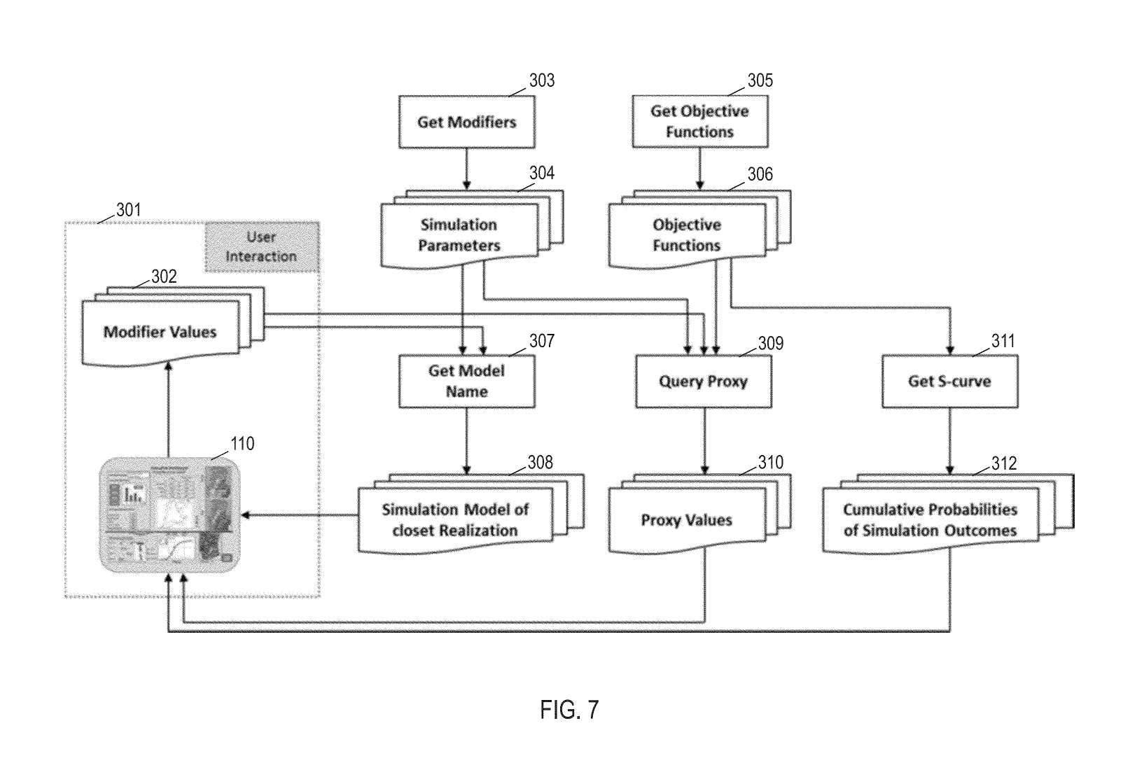

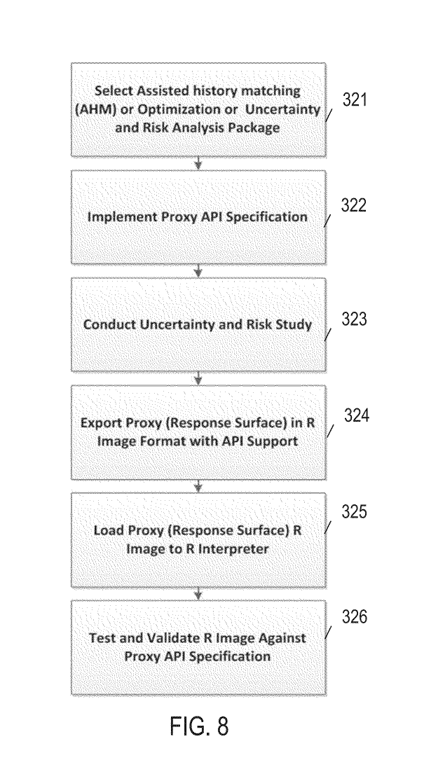

For example, systems and methods related to a proxy API according to an embodiment are further illustrated in FIG. 2, FIG. 3, FIG. 5, FIG. 7, and FIG. 8, for example. Routines defined in a proxy API can be implemented in a programming language and environment for statistical computations such as that provided by R language. As will be understood by those skilled in the art, R language is designed for efficient statistical computations and data mining operations. The proxy API specification in R image format can provide interoperability of a dashboard 110 with technologies used in various simulation proxies, as illustrated in FIG. 3, for example. Exported R images files 125 can then be loaded into an R interpreter 115, which can be connected to dashboard 110. Dashboard 110 can communicate with the R interpreter 115 through the set of function calls specified in the proxy API and implemented in the R images files 125 loaded into the R interpreter 115.

An example of proxy access from dashboard 110 though a single proxy API is illustrated in FIG. 5. As illustrated in FIG. 5, for example, a dashboard 110 can communicate with an R interpreter 115 by use of proxy API queries to thereby enable interrogation of a number of proxies in R image format. As depicted, proxies can include proxy (response surface model) A in R image format 204, proxy (response surface model) B in R image format 205, proxy (response surface model) i in R image format 206, proxy (response surface model) J in R image format 207, and proxy (response surface model) N in R image format 208, as well as other proxy technologies and proxies 209 and 210. Further, the unconverted proxies can have been generated using different technologies. For example, proxy (response surface model) A in R image format 204 and proxy (response surface model) B in R image format 205 can be associated with proxy-creation technology X 201. In contrast, proxy (response surface model) i in R image format 206 and proxy (response surface model) J in R image format 207 can be associated with a different proxy-creation technology Y 202. Further, proxy (response surface model) N in R image format 208 can be associated with proxy-creation technology M 203. Proxies can be converted into R image format prior to interrogation. For example, the exemplary integrated reservoir study 200 illustrated in FIG. 3 depicts proxy (response surface model) access from a dashboard 110 according to an embodiment of the invention. As illustrated in FIG. 3, a number of simulation studies, including simulation study 1 216, simulation study 2 217, and other simulation studies through simulation study N 218 can each have an associated proxy model. For example, proxy-creation technology 1 225 can be used to generate proxy model 1 219—associated with simulation study 1 216—and proxy model 2 220—associated with simulation study 2 217. Proxy-creation technology M 203, on the other hand, can be used to generate proxy model N 221, associated with simulation study N 218. Each proxy model can be converted to R image format to produce proxy (response surface model) 1 in R image format 222, proxy (response surface model) 2 in R image format 223, and proxy (response surface model) N in R image format 208, respectively. The R interpreter 115 can then be used to interrogate the proxies in R image format.

Embodiments of the invention can thus relate to building an interoperable interface between a dashboard 110 and various response surface models (proxies) in a database. Users can access simulation information—in some instances, stored in a simulation results database 215, as illustrated in FIG. 3, for example—for quick examination of studies and explore various alternative scenarios using a dashboard 110, as illustrated in FIG. 4, for example. That is, in some circumstances, displaying can include selectively displaying one or more uncertainty characteristics of each of the one or more of the surface model proxies on the electronic user interface 106 by use of the proxy API. The proxy API can thus provide a mechanism to interrogate a response function. The one or more uncertainty characteristics can be configured to include an S-curve related to each of the surface model proxies. Further, each of the one or more S-curves can depict cumulative probabilities of simulation outcome data, as illustrated in FIG. 4, for example. An S-curve can further depict interpolated estimations of simulation outcome data, for example. S-curves thus can be analyzed to estimate one or more probabilities of simulation outcome for one or more potential simulation scenarios yet to be run to thereby enhance probing of the one or more hydrocarbon reservoir simulation models. For example, by utilizing the surface model proxies to provide information on risk and uncertainty, a user can reduce the number of simulation runs that must be completed in a simulation study. For instance, a summary of a set of study illustrated by an S-curve for a particular objective function is illustrated in FIG. 4. That is, an exemplary dashboard 110 showing a set of a simulation study, as well as proxy interpolation, is illustrated in FIG. 4. As depicted, three “modifiers” (simulation parameters) can be varied to probe response function models. Modifiers—sometimes described as “simulation parameters” or “hydrocarbon reservoir simulation run parameters,” as noted above—can relate to simulation parameters that were used as input for a given study or as input for a proxy, for example. A user can vary modifiers by using sliding bars, e.g., Modifier 1 bar 265, Modifier 2 bar 266, and Modifier 3 bar 267, and query a proxy (by use of a Query Proxy button 268) interactively from dashboard 110. This can in turn update an indicator 262 on the S-curve 261 to show corresponding cumulative probabilities for different sets of simulations. That is, indicator 262 on S-curve 261, which can be derived from a set of simulation runs, can show the relationship between the risk factor (opposite to cumulative probability) and an objective 263 (i.e., a target output), if a run were to be made with the chosen modifiers, as determined by the values set in the slide bars 265, 266, and 267. Consequently, one can obtain a response surface value for a selected set of modifiers.

In addition, in some circumstances, each of the one or more S-curves can include (1) a statistically most likely point and (2) an output value of the related one of the surface model proxies for a preselected set of hydrocarbon reservoir simulation run parameters with respect to the surface model proxies (i.e., a hydrocarbon reservoir simulation response surface model proxy outcome associated with a preselected set of hydrocarbon reservoir simulation run parameters with respect to the hydrocarbon reservoir simulation response surface model proxy). For example, dashboard 110 can be implemented using proxy API routines as illustrated, for example, in FIG. 4. An exemplary S-curve 261, which can relate to a particular strategy, for example, can correspond to a proxy generated using a set of simulation runs. Different modifiers' values can be changed using slide bars in the left hand side of the dashboard 110, i.e., Modifier 1 bar 265, Modifier 2 bar 266, and Modifier 3 bar 267. This dashboard 110 can allow a user to estimate how the probability of a simulation result would change as modifier values are changed. That is, an S-curve 261 can depict the relationship between an objective 263 (i.e., a target output) of a simulation and a measure of cumulative probability (i.e., a risk factor 264). As a result, the user can experiment with modifier values to better quantify uncertainty and risk. A proxy API routine can provide an approach to design an exemplary dashboard 110 with an interface of various response surface models built with diverse underlying technology. This example dashboard 110 can be used to analyze alternative simulation strategies (e.g., pattern water flood, gas injection, water-alternating-gas (WAG), and peripheral water injection strategies) represented by individual S-curves. Each S-curve can represent the cumulative probability outcome of a specific objective function (e.g., cumulative oil production) selected from dashboard 110. The S-curve shape (i.e., narrow versus wide) can indicate the spread of each strategy outcome. That is, a wider S-curve can indicate a greater range of probabilities. Dashboard 110 can be similarly used to analyze alternative well tactic cases such as vertical, horizontal, multilateral, and flank wells, as will be understood by those skilled in the art.

In a system according to an embodiment, in some circumstances, the instructions can further cause the one or more processors 101 to perform the step of creating the one or more of the surface model proxies, responsive to input from the one or more input and output units 104.

Embodiments can also include computer-implemented methods to enhance probing of hydrocarbon reservoir simulation models. For example, a computer-implemented method can include initiating a proxy application programming interface (API) to thereby interrogate one or more of one or more different hydrocarbon reservoir simulation response surface model proxies. The one or more different hydrocarbon reservoir simulation response surface model proxies can thereby define surface model proxies. Additionally, each of the surface model proxies can be associated with one of one or more hydrocarbon reservoir simulation models. Furthermore, the surface model proxies can have a common image format based on a conversion from a plurality of different simulation model technology formats to the common image format. In addition, the proxy API can be configured to include a plurality of different preselected operations. A method can also include interpreting each of the one or more of the surface model proxies to thereby retrieve a simulation data set for each of the one or more of the surface model proxies responsive to each of the plurality of different preselected operations of the proxy API, for example. Further, a method can include displaying—for each of the one or more of the surface model proxies—one or more results of each of the plurality of different preselected operations of the proxy API to thereby probe the associated hydrocarbon reservoir simulation models.

In some circumstances, the proxy API can relate to an environment for statistical computing that includes R programming language, and the common image format can include R image format. Further, interpreting each of the one or more of the surface model proxies can include translating one or more R image files associated with each of the one or more of the surface model proxies into a format readable by the proxy API to thereby retrieve predetermined data from the one or more of the surface model proxies, responsive to a user request.

Displaying can include selectively displaying one or more uncertainty characteristics of each of the one or more of the surface model proxies by use of the proxy API. In addition, the one or more uncertainty characteristics can be configured to include an S-curve related to each of the surface model proxies. An S-curve can be used, for example, to estimate one or more probabilities of simulation outcome for one or more potential simulation scenarios yet to be run to thereby enhance probing of the one or more hydrocarbon reservoir simulation models. Each of the one or more S-curves can depict cumulative probabilities of simulation outcome data. Additionally, each of the one or more S-curves can include a statistically most likely point and an output value of the related one of the surface model proxies for a preselected set of hydrocarbon reservoir simulation run parameters with respect to the surface model proxies. Further, in some circumstances, a method can also include creating the one or more of the surface model proxies responsive to user input. The one or more uncertainty characteristics can include a proxy value (i.e., output value of a proxy) responsive to a set of most likely hydrocarbon reservoir simulation run parameters. Further, one or more of the plurality of different preselected operations of the proxy API can responsively enhance one or more workflows for hydrocarbon field development plans. Additionally, one or more third-party tools can implement the one or more workflows for hydrocarbon reservoir field development plans.

In some circumstances, the plurality of different preselected operations of the proxy API can include determining—responsive to a first preselected simulation objective—an output value of one or more of the surface model proxies for a first preselected set of hydrocarbon reservoir simulation run parameters with respect to the surface model proxies to thereby query the one or more of the surface model proxies. The plurality of different preselected operations of the proxy API can also include identifying—responsive to a second preselected simulation objective—one of the hydrocarbon reservoir simulation models associated with one of the surface model proxies when the one of the surface model proxies has an output value for a second preselected set of hydrocarbon reservoir simulation run parameters with respect to the surface model proxies that is closest to output values of a preselected simulation scenario to thereby define a closest model.

Further, the plurality of different preselected operations of the proxy API can include identifying—responsive to a third preselected simulation objective—two of the hydrocarbon reservoir simulation models each associated with one of the surface model proxies when: (1) one of the two of the surface model proxies has an output value for a third preselected set of hydrocarbon reservoir simulation run parameters with respect to the surface model proxies that is closest to the output value of another preselected simulated scenario among output values higher than the output value of the other preselected simulated scenario and (2) the other of the two of the surface model proxies has an output value for the third preselected set of hydrocarbon reservoir simulation run parameters that is closest to the output value of the other preselected simulated scenario among output values lower than the output value of the other preselected simulated scenario. The two hydrocarbon reservoir simulation models can thereby define close realization bracketing models, for example. That is, at least one of the plurality of different preselected operations of the proxy API can include identifying one or more of the surface model proxies that have close realization bracketing for a preselected set of hydrocarbon reservoir simulation run parameters with respect to the surface model proxies. The plurality of different preselected operations of the proxy API can also include identifying names of one or more hydrocarbon reservoir simulation run parameters with respect to the surface model proxies responsive to a fourth preselected simulation objective to thereby return the identified one or more hydrocarbon reservoir simulation run parameters.

In some instances, each of the plurality of different simulation model technology formats can be associated with a unique set of one or more algorithms used to create a hydrocarbon reservoir simulation response surface model proxy and with a unique technology vendor. Further, each of the one or more of the surface model proxies can be configured to simulate performance for a respective preselected period of desired time. For example, one or more of the surface model proxies can each be generated responsive to one or more hydrocarbon reservoir simulation study approaches dissimilar from a hydrocarbon reservoir simulation study approach used to generate another one or more of the surface model proxies. Hydrocarbon reservoir simulation study approaches dissimilar from one another can include an assisted history matching study, a predictive study, an optimization study, and an uncertainty and risk analysis study, for example. A method can further include displaying on a display—by use of the proxy API—observed reservoir characteristic values for one or more of the one or more hydrocarbon reservoirs to a user.

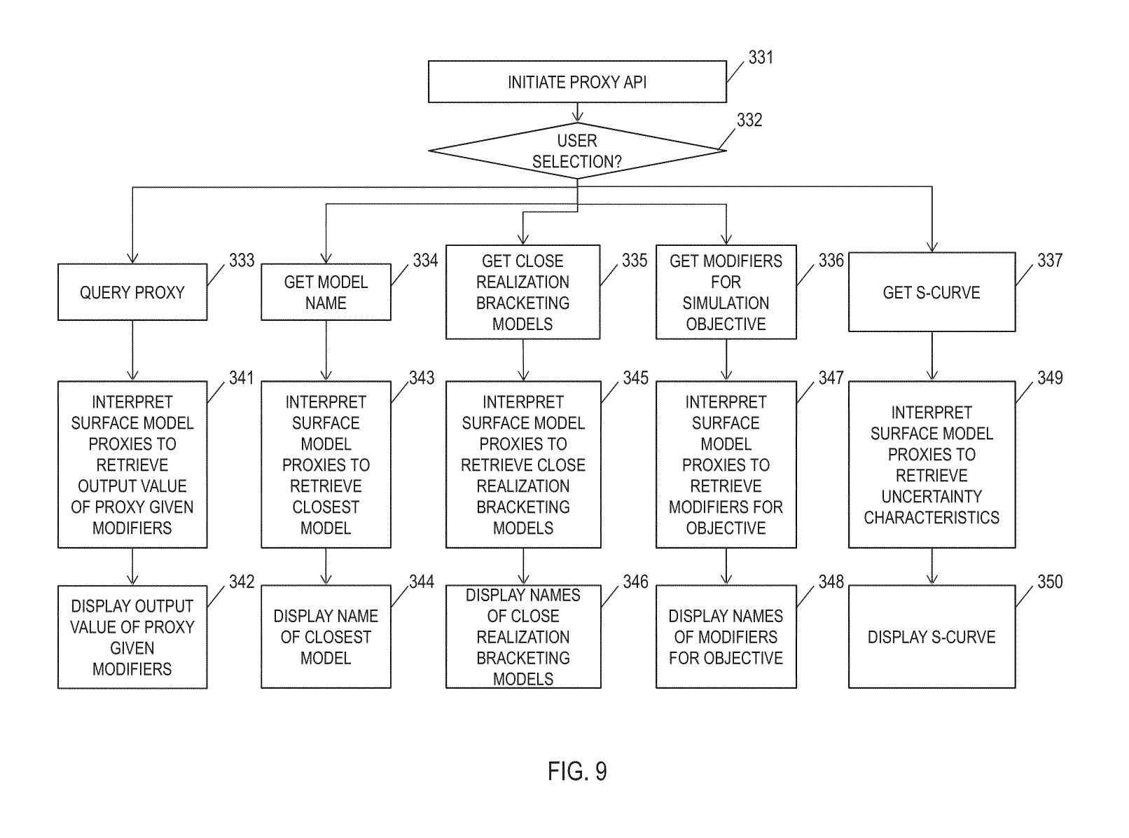

For example, a method according to an embodiment is illustrated in FIG. 9. A method as illustrated in FIG. 9 can include, for instance, initiating the proxy API 331 before determining which of a plurality of operations of the proxy API a user selects 332. If the user chooses to query a proxy 333, a method can then include interpreting the proxies to retrieve a simulation data set that includes the output value of the queried proxy for a set of modifiers 341 and displaying that output value 342. If the user selects “get model name” 334, however, a method can include interpreting the proxies to retrieve a simulation data set that includes the hydrocarbon reservoir simulation model associated with a proxy that has the closest output value for a selected scenario 343. A method can then include displaying the name of that model 344. If the user chooses to identify hydrocarbon reservoir simulation models having close realization bracketing 335, a method can include interpreting the proxies to retrieve a simulation data set that includes the models that have close realization bracketing 345 and displaying the names of those models 346. If the user selects to identify modifiers associated with a particular simulation objective 336, a method can include interpreting the proxies to retrieve a simulation data set that includes the associated modifiers 347. A method can then include displaying the names of the modifiers 348. Further, if the user selects “get S-curve” 337, a method can include interpreting the proxies to retrieve a simulation data set that includes uncertainty characteristics of one of the proxies 349 and displaying the corresponding S-curve 350. A user can choose to query a proxy 333 by, for example, calling a queryProxy 246 operation of the proxy API, as illustrated, for example, in FIG. 2. A dashboard 110 can include a Query Proxy button 268, as illustrated in FIG. 4, for example, to enable a user to call the queryProxy 246 operation. Likewise, a user can select “get model name” 334 by calling a GetModelName 248 operation of the proxy API. A user can similarly choose to get models that have close realization bracketing 335 by calling a GetBracketModel 247 operation of the proxy API. Further, a user can choose to get an S-curve 337 by calling a GetSCurve 245 operation of the proxy API.

Implementing embodiments of the current invention in designing a dashboard 110 can include two phases, for instance. First, steps can be taken to implement embodiments of the invention, including a proxy API, in a new assisted history matching (AHM), optimization, uncertainty, or risk analysis package. Next, proxy API routines can be used to develop applications and dashboards, for example.

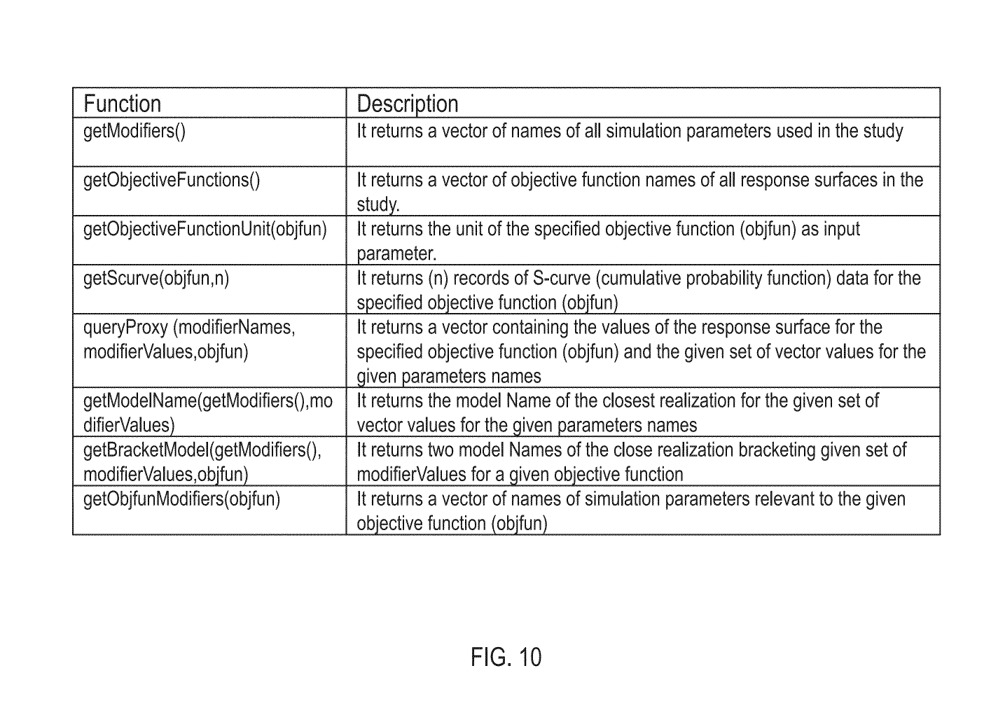

Implementation and validations details of proxy API routines are further illustrated, for example, in FIG. 8. For example, steps to implement a proxy API can include, as illustrated in FIG. 8: (1) simulation engineers can perform studies for a given objective (e.g., history matching, field optimization, etc.); (2) a proxy (response surface model) can be created for each set of study; (3) functionalities can be implemented to support R functions as described in the table in FIG. 10, for example; (4) an R-image file of the proxy for each set of study can be created and stored in a database; and (5) dashboard functionalities can be developed using one or more of the routines described herein and represented in the table in FIG. 10, for example. That is, as illustrated in FIG. 8, for example, steps can include: selecting an assisted history matching (AHM), optimization, or uncertainty and risk analysis package 321; implementing a proxy API specification 322; conducting uncertainty and risk studies 323; exporting a proxy (response surface) in R image format with API support 324; loading a proxy (response surface) in R image format to an R interpreter 325; and testing and validating an R image file against a proxy API specification 326. Testing and validating an R image file against a proxy API specification 326 can be a quality control or validation step to validate an R image file after its creation.

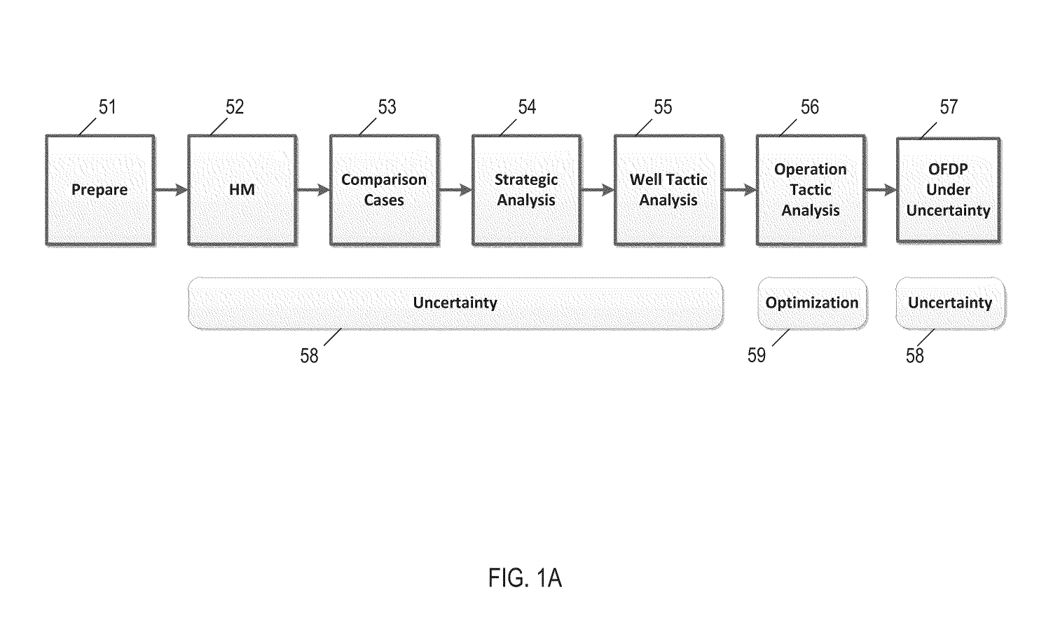

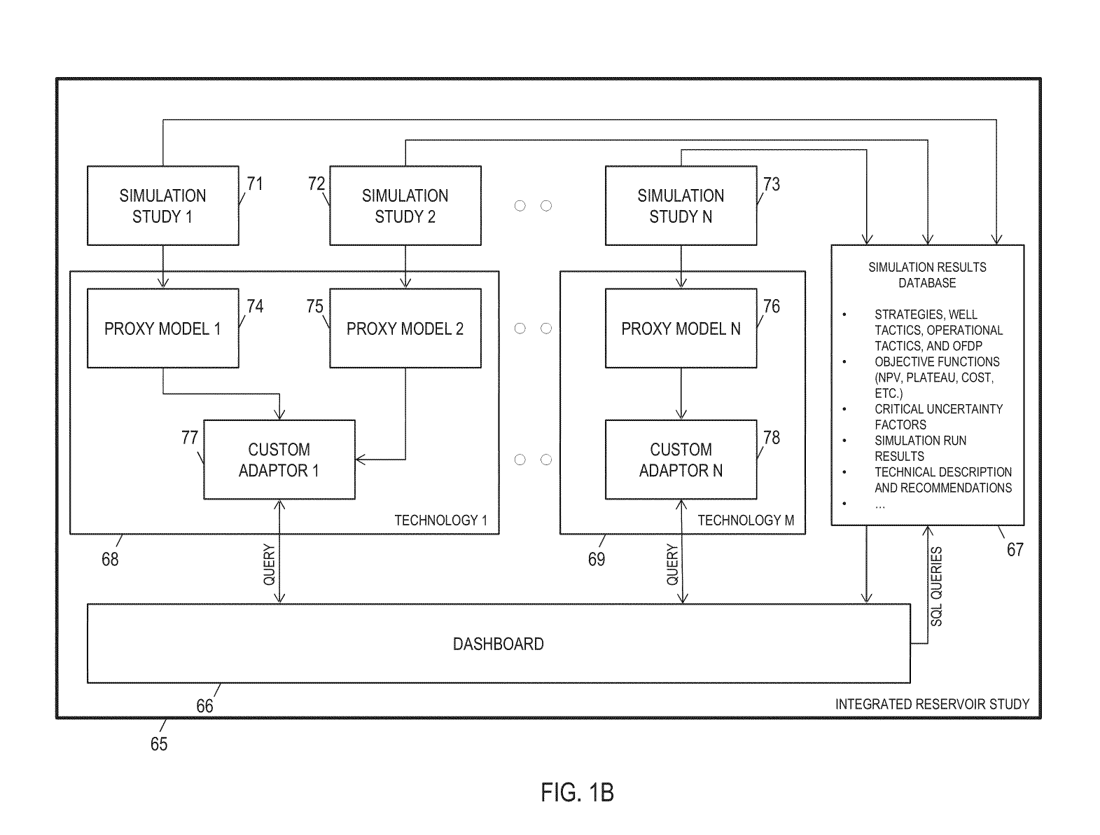

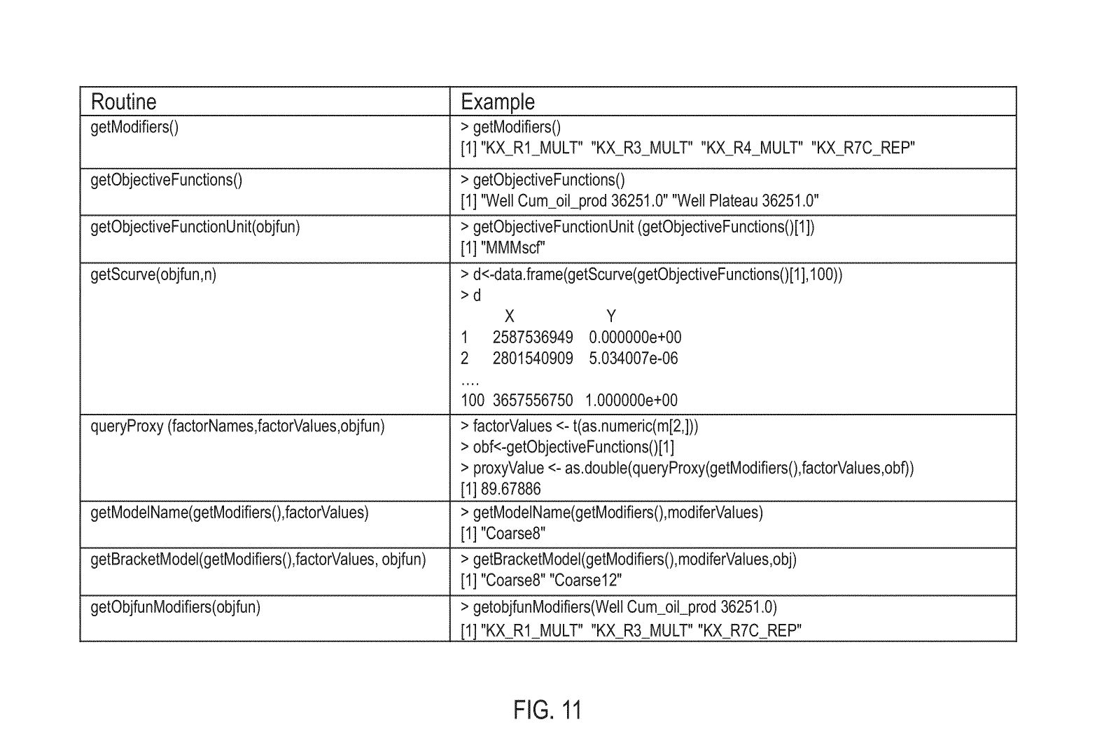

Proxy API routines can then be used to develop applications and dashboards. As noted, proxy R image files can be generated for each set of a simulation study loaded to a simulation results database 215. A dashboard 110 can be connected to an R package/library and can be able to communicate to proxies through the proxy API. Functionalities of a proxy API can include, for example: (1) accessing a response surface for values of objective functions for a given set of input parameters (using routine queryProxy 246); (2) accessing cumulative probability function data or an S-curve for a specific objective function (using routine getScurve 245); (3) determining the simulation model name with a closest realization for a given set of parameters (using routine getModelName 248); and (4) determining simulation model names with closest realizations bracketing a given set of parameters (using routine getBracketModel 247). For example, interactions between these routines 242 and application data 243 within an application 240 are illustrated in FIG. 2. An application 240, for example, can include a dashboard 110 that can provide input to an API and display output of the API. Further, a dashboard 110 can include a visualization window 241, for example. Application data 243 can include, for example, Modifiers list 249 and Objfunction list 250. Selection of routine GetSCurve 245 can interact with application data 243 to retrieve S-curve data 253. A user can also select routine queryProxy 246, for example. Further, selection of GetModelName 248 can retrieve a name, such as, for example, Coarse8 252, where “Coarse8” is a simulation model name. Similarly, selection of GetBracketModel 247 can retrieve two names, e.g., Coarse8Coarse12 251. Some of the functions of the proxy API can include those listed in the tables in FIG. 10 and FIG. 11, for example. That is, functionalities of some proxy API routines are listed in the table in FIG. 10, for example, and proxy API routines with examples of implementations and related input/output parameters are listed in the table in FIG. 11, for example. These proxy API functionalities, for example, can responsively enhance one or more workflows for hydrocarbon field development plans, such as workflows to accelerate the delivery of OFDP, as illustrated in FIG. 1A, for example.

A workflow and interdependencies of the routines defined in a proxy API, as described in FIG. 10, for example, are shown in FIG. 7, for instance. More specifically, FIG. 7 depicts a workflow designed using proxy API routines and, in particular, a workflow to design a dashboard 110 using proxy API routines. All routines can access a set of stored response surface models (proxies) of reservoir simulation studies. These response surface models can be implemented as R image files (built using R language utilities). API routines getModifiers and getObjectiveFunctions can be called from a dashboard 110 and can return lists of modifiers (simulation parameters) and objective functions, respectively, to the dashboard 110. Users then can interrogate the response surface models through the dashboard 110, which can call the routines defined in the proxy API. These routines can then probe the R image files of response surface models to return users' requested information to the dashboard 110. For example, as depicted in FIG. 7, a get modifiers routine 303 can return simulation parameters 304, whereas a get objective functions routine 305 can return a list of objective functions 306. Simulation parameters 304, along with modifier values 302, can be used as inputs to a get model name routine 307, which can then return a simulation model of the closest realization 308. Likewise, objective functions 306 can be used with modifier values 302 and simulation parameters 304 as inputs to a query proxy routine 309, which can return proxy values 310. Objective functions 306 can also be used as input to a get S-curve routine 311, which can then return cumulative probabilities of simulation outcomes 312. Further, user interaction 301 can include selection of modifier values 302 and interaction with a dashboard 110, for example. Inputs to dashboard 110 can include simulation model of closest realization 308, proxy values 310, and cumulative probabilities of simulation outcomes 312, for example. A user can then use dashboard 110 to select modifier values 302.

A goal of the current API design can include providing a mechanism to efficiently probe response surface models (e.g., R image files) for uncertainty (statistical) analysis. Return values of these routines can also be used in interfaces other than a dashboard 110. An example of such implementation is shown in FIG. 2, where the getModelName routine 248 can return the name of the model (or case study) with the closest proxy value (probability of the objective function) for the user-selected parameter (modifier) values from the response surface models built according to a proxy API. The model name information can then be used to visualize some reservoir field data (e.g., oil saturation) in a visualization window 241 as illustrated, for example, in FIG. 2.

An example of how a proxy API can be implemented to display an S-curve plot for each reservoir simulation study in an integrated study can include, for example, a user's selecting an objective function from a dashboard 110. A dashboard 110 can then communicate with an R interpreter 115 to get the actual objective function name used in the R image file using, for example, the following code:
obf<-obffunmap[objfunmap[,1]==objfun,][,2]
   The dashboard 110 can then communicate with the R interpreter 115 to load the R image file and query the S-curves of the selected objective function using the following code:

rfile <- CaseTable[CaseTable[,1]==Case,][,2]
load(file=rfile)
scurve <- getScurve(obf,n)

Communicating with the R interpreter 115 to load an R image file and query the S-curves of a selected objective function can be done for all studies in an integrated study, for example. The returned S-curve data from the R image can then be plotted in the dashboard 110. For each S-curve, the dashboard 110 can communicate with the R interpreter 115 to query the objective function value for the most likely reservoir simulation run parameters using the following code:

factorNames <- ModifierTable[,1]
factorValues <- t(as.numeric(ModifierTable[,2]))
ifelse(!is.element(obf,getObjectiveFunctions( )),
obf<-getObjectiveFunctions( )[1],obf<-obf)
proxyValue<-s.double(queryProxy(factorNames,factorValues,obf))

Most likely reservoir simulation run parameters can be determined, for example, by a simulation engineer based on the simulation engineer's prior knowledge of a problem to which the simulation engineer needs an answer, e.g., finding the duration of a production plateau. The returned proxy value can then be highlighted on the S-curve. From the dashboard 110, a user can also change the modifiers' values, representing simulation input parameters, to get an estimated objective function value based on the R image proxy file. Upon user selection of a Query Proxy button 268, the dashboard 110 can submit a list of the modifiers' values to the R interpreter 115 to query the estimated objective function value on the S-curve using the following code:

cc <- strsplit(factorsString,“;”)
m <- matrix(unlist(strsplit(unlist(cc),“:”)),nrow=2)
factorNames <- m[1,]
factorValues <- t(as.numeric(m[2,]))
ifelse(!is.element(obf,getObjectiveFunctions( )),obf<-
getObjectiveFunctions( )[1],obf<-obf)
proxyValue<- as.double(queryProxy(factorNames,factorValues,obf))
Scurves <- getScurve(obf,n)
center.value <- proxyValue

Embodiments can still further include non-transitory computer-readable medium having one or more computer programs stored therein operable by one or more processors to enhance probing of hydrocarbon reservoir simulation models. For example, in non-transitory computer-readable medium having one or more computer programs stored therein operable by one or more processors according to an embodiment, the one or more computer programs can include a set of instructions that, when executed by the one or more processors, cause the one or more processors to perform a series of operations. The operations performed by the one or more processors can include, for example, initiating a proxy application programming interface (API) to thereby interrogate one or more of one or more different hydrocarbon reservoir simulation response surface model proxies. The one or more different hydrocarbon reservoir simulation response surface model proxies can thereby define surface model proxies, and each of the surface model proxies can be associated with one of one or more hydrocarbon reservoir simulation models. Further, the surface model proxies can have a common image format based on a conversion from a plurality of different simulation model technology formats to the common image format, for example. In addition, the proxy API can be configured to include a plurality of different preselected operations. The operations performed by the one or more processors can also include, for example, interpreting each of the one or more surface model proxies to thereby retrieve a simulation data set for each of the one or more of the surface model proxies responsive to each of the plurality of different preselected operations of the proxy API. Each simulation data set of the one or more of the surface model proxies can include one or more uncertainty characteristics associated with one or more hydrocarbon reservoirs, for example. The operations performed by the one or more processors can further include displaying—for each of the one or more of the surface model proxies—one or more results of each of the plurality of different preselected operations of the proxy API to thereby probe the associated hydrocarbon reservoir simulation models.

In some circumstances, displaying can include selectively displaying one or more uncertainty characteristics of each of the one or more of the surface model proxies by use of the proxy API. In some circumstances, the one or more uncertainty characteristics can include a proxy value responsive to a set of most likely hydrocarbon reservoir simulation run parameters. Further, the one or more uncertainty characteristics can be configured to include an S-curve related to each of the surface model proxies. Consequently, operations of the proxy API can estimate one or more probabilities of simulation outcome for one or more potential simulation scenarios yet to be run to thereby enhance probing of the one or more hydrocarbon reservoir simulation models. Each of the one or more S-curves can depict cumulative probabilities of simulation outcome data, for example. In some circumstances, each of the one or more S-curves can include a statistically most likely point and an output value of the related one of the surface model proxies for a preselected set of hydrocarbon reservoir simulation run parameters with respect to the surface model proxies. Further, one or more of the plurality of different preselected operations of the proxy API can responsively enhance one or more workflows for hydrocarbon field development plans. In addition, one or more third-party tools can implement the one or more workflows for hydrocarbon reservoir field development plans.

In some circumstances, the plurality of different preselected operations of the proxy API can include, for example, determining—responsive to a first preselected simulation objective—an output value of one or more of the surface model proxies for a first preselected set of hydrocarbon reservoir simulation run parameters with respect to the surface model proxies to thereby query the one or more of the surface model proxies. The plurality of different preselected operations of the proxy API can also include identifying—responsive to a second preselected simulation objective—one of the hydrocarbon reservoir simulation models associated with one of the surface model proxies when the one of the surface model proxies has an output value for a second preselected set of hydrocarbon reservoir simulation run parameters with respect to the surface model proxies that is closest to output values of a preselected simulation scenario. The identified hydrocarbon reservoir simulation model can thereby define a closest model, for example.

Additionally, the plurality of different preselected operations of the proxy API can include identifying—responsive to a third preselected simulation objective—two of the hydrocarbon reservoir simulation models each associated with one of the surface model proxies when: (1) one of the two of the surface model proxies has an output value for a third preselected set of hydrocarbon reservoir simulation run parameters with respect to the surface model proxies that is closest to the output value of another preselected simulated scenario among output values higher than the output value of the other preselected simulated scenario and (2) the other of the two of the surface model proxies has an output value for the third preselected set of hydrocarbon reservoir simulation run parameters that is closest to the output value of the other preselected simulated scenario among output values lower than the output value of the other preselected simulated scenario. As a result, the two hydrocarbon reservoir simulation models can thereby define close realization bracketing models. The plurality of different preselected operations of the proxy API can also include identifying names of one or more hydrocarbon reservoir simulation run parameters with respect to the surface model proxies, responsive to a fourth preselected simulation objective, to thereby return the identified one or more hydrocarbon reservoir simulation run parameters.

Further, the proxy API can relate to an environment for statistical computing that includes R programming language. The common image format can include R image format, for example. Additionally, interpreting each of the one or more of the surface model proxies can include translating one or more R image files associated with each of the one or more of the surface model proxies into a format readable by the proxy API to thereby retrieve predetermined data from the one or more of the surface model proxies responsive to user request.

Additionally, each of the plurality of different simulation model technology formats can be associated with a unique set of one or more algorithms used to create a hydrocarbon reservoir simulation response surface model proxy and with a unique technology vendor. Further, each of the one or more of the surface model proxies can be configured to simulate performance for a respective preselected period of desired time. For example, one or more of the surface model proxies can each be generated responsive to one or more hydrocarbon reservoir simulation study approaches dissimilar from a hydrocarbon reservoir simulation study approach used to generate another one or more of the surface model proxies. Further, for example, hydrocarbon reservoir simulation study approaches dissimilar from one another can include an assisted history matching study, a predictive study, an optimization study, and an uncertainty and risk analysis study, in some instances. The operations performed by the one or more processors can also include creating the one or more of the surface model proxies responsive to user input. The operations can further include, in some instances, displaying on a display—by use of the proxy API—observed reservoir characteristic values for one or more of the one or more hydrocarbon reservoirs to a user, for example.

Embodiments can fulfill a need for an effective technique for standardization of access to diverse reservoir simulation proxies, which can be used to support reservoir management dashboards for uncertainty analyses. That is, embodiments can include a standard for a reservoir simulation response surface model (proxy) interface to provide interoperability among diverse response surface models (proxies). Further, embodiments can include methods (functionalities) for development of a dashboard for reservoir management under uncertainty. Embodiments of the invention can thus advantageously enable development of a novel unified method to interface with a proxy API, which can allow for interchanging and ease of development of scientific workflows. Embodiments can also include a mechanism to couple with multiple and diverse response surfaces through a proxy API, which can provide a unified access methodology.

By capitalizing on a common application programming interface for interrogating uncertainty and risk information in proxies (response surface models), cost avoidance for an entity can in some circumstances exceed $300,000, in the form of avoided consultation and in-house development. Furthermore, an entity that implements embodiments of the invention can continue to benefit from such cost avoidance as more advanced applications and dashboards are developed. In addition, any need to maintain custom links and connectors to vendor-specific proxy implementations can be avoided. This can constitute an additional cost avoidance of $100,000 per year. Furthermore, embodiments can also allow an entity to capitalize on uncertainty and risk information to make informed business decisions, which can have significant value to the entity's efficiency and performance. For example, embodiments can allow easy access to all integrated hydrocarbon reservoir study data, decisions, and critical study results, including all associated uncertainty and risk, to a wide, multidisciplinary technical and management team. Consequently, embodiments can be particularly advantageous to integrated study teams, such as asset teams or integrated reservoir study (IRS) teams.

A proxy API can be used to interrogate reservoir simulation response surface models. By capitalizing on embodiments of the invention, an entity's operations can be optimized, and manpower and resources can be used more efficiently. Embodiments can also eliminate any potential vendor lock-in or dependence on vendor-specific implementations by eliminating the need for high-overhead, complex links that are required to integrate a dashboard with different vendor proxy (response surface models) implementations. In addition, any need to continually revise a developed dashboard whenever a vendor implementation is updated or changed can be eliminated. Furthermore, embodiments can accelerate project delivery by eliminating many possible project show-stoppers, including vendor resistance to sharing underlying implementation details required to develop custom links, and can allow all project participants to focus on their expertise.

In the various embodiments of the invention described herein, a person having ordinary skill in the art will recognize that various types of memory are readable by a computer, such as the memory described herein in reference to the various computers and servers, e.g., computer, computer server, web server, or other computers with embodiments of the present invention. Examples of computer readable media can include but are not limited to: nonvolatile, hard-coded type media, such as read only memories (ROMs), CD-ROMs, and DVD-ROMs, or erasable, electrically programmable read only memories (EEPROMs); recordable type media, such as floppy disks, hard disk drives, CD-R/RWs, DVD-RAMs, DVD-R/RWs, DVD+R/RWs, flash drives, memory sticks, and other newer types of memories; and transmission type media such as digital and analog communication links. For example, such media can include operating instructions, as well as instructions related to the systems and the method steps described above and can operate on a computer. It will be understood by those skilled in the art that such media can be at other locations instead of, or in addition to, the locations described to store computer program products, e.g., including software thereon. It will be understood by those skilled in the art that the various software modules or electronic components described above can be implemented and maintained by electronic hardware, software, or a combination of the two, and that such embodiments are contemplated by embodiments of the present invention.

In the drawings and specification, there have been disclosed embodiments of methods, systems, and non-transitory computer-readable medium having computer program stored therein of the present invention, and although specific terms are employed, the terms are used in a descriptive sense only and not for purposes of limitation. The embodiments of methods, systems, and non-transitory computer-readable medium having computer program stored therein of the present invention have been described in considerable detail with specific reference to these illustrated embodiments. It will be apparent, however, that various modifications and changes can be made within the spirit and scope of the embodiments of methods, systems, and non-transitory computer-readable medium having computer program stored therein of the present invention as described in the foregoing specification, and such modifications and changes are to be considered equivalents and part of this disclosure.

That claimed is:

1. A system to enhance probing of hydrocarbon reservoir simulation models, the system comprising:
one or more processors;
one or more databases in communication with the one or more processors and having data associated with one or more different hydrocarbon reservoir simulation response surface model proxies to thereby define surface model proxies stored therein, the surface model proxies having a common image format based on a conversion from a plurality of different simulation model technology formats to the common image format, each of the surface model proxies being associated with one of one or more hydrocarbon reservoir simulation models;
one or more input and output units in communication with the one or more processors and positioned to receive input and output communication;
a display in communication with the one or more processors and configured to display an electronic user interface thereon; and
non-transitory memory medium in communication with one or more of the one or more processors, the memory medium having computer-readable instructions stored therein that when executed cause the one or more processors to perform the steps of:
initiating a proxy application programming interface (API), responsive to user request through the one or more input and output units, to thereby interrogate one or more of the surface model proxies from the one or more databases, the proxy API configured to include a plurality of different preselected operations,
interpreting each of the one or more of the surface model proxies to thereby retrieve a simulation data set for each of the one or more of the surface model proxies responsive to each of the plurality of different preselected operations of the proxy API, and
displaying, through the electronic user interface on the display, for each of the one or more of the surface model proxies, one or more results of each of the plurality of different preselected operations of the proxy API to thereby probe the associated hydrocarbon reservoir simulation models.

2. A system as defined in claim 1, wherein displaying includes selectively displaying one or more uncertainty characteristics of each of the one or more of the surface model proxies on the electronic user interface by use of the proxy API, the one or more uncertainty characteristics configured to include an S-curve related to each of the surface model proxies, and wherein each of the one or more S-curves depicts cumulative probabilities of simulation outcome data.

3. A system as defined in claim 2, wherein each of the one or more S-curves includes a statistically most likely point and an output value of the related one of the surface model proxies for a preselected set of hydrocarbon reservoir simulation run parameters with respect to the surface model proxies.

4. A system as defined in claim 3, wherein one or more of the plurality of different preselected operations of the proxy API responsively enhance one or more workflows for hydrocarbon field development plans.

5. A system as defined in claim 4, wherein one or more third-party tools implement the one or more workflows for hydrocarbon reservoir field development plans.

6. A system as defined in claim 1, wherein the plurality of different preselected operations of the proxy API include each of:
determining, responsive to a first preselected simulation objective, an output value of one or more of the surface model proxies for a first preselected set of hydrocarbon reservoir simulation run parameters with respect to the surface model proxies to thereby query the one or more of the surface model proxies;
identifying, responsive to a second preselected simulation objective, one of the hydrocarbon reservoir simulation models associated with one of the surface model proxies when the one of the surface model proxies has an output value for a second preselected set of hydrocarbon reservoir simulation run parameters with respect to the surface model proxies that is closest to output values of a preselected simulation scenario to thereby define a closest model;
identifying, responsive to a third preselected simulation objective, two of the hydrocarbon reservoir simulation models each associated with one of the surface model proxies when one of the two of the surface model proxies has an output value for a third preselected set of hydrocarbon reservoir simulation run parameters with respect to the surface model proxies that is closest to the output value of another preselected simulated scenario among output values higher than the output value of the other preselected simulated scenario and when the other of the two of the surface model proxies has an output value for the third preselected set of hydrocarbon reservoir simulation run parameters that is closest to the output value of the other preselected simulated scenario among output values lower than the output value of the other preselected simulated scenario, the two hydrocarbon reservoir simulation models thereby defining close realization bracketing models; and
identifying names of one or more hydrocarbon reservoir simulation run parameters with respect to the surface model proxies responsive to a fourth preselected simulation objective to thereby return the identified one or more hydrocarbon reservoir simulation run parameters.

7. A system as defined in claim 1, wherein the proxy API relates to a system environment for statistical computing that includes R programming language, wherein the common image format includes R image format, and wherein interpreting each of the one or more of the surface model proxies includes translating one or more R image files associated with each of the one or more of the surface model proxies into a format readable by the proxy API to thereby retrieve predetermined data from the one or more of the surface model proxies responsive to user request.

8. A system as defined in claim 1, wherein each of the plurality of different simulation model technology formats is associated with a unique set of one or more algorithms used to create a hydrocarbon reservoir simulation response surface model proxy and with a unique technology vendor, and wherein each of the one or more of the surface model proxies is configured to simulate performance for a respective preselected period of desired time.

9. A computer-implemented method to enhance probing of hydrocarbon reservoir simulation models, the method comprising:
initiating a proxy application programming interface (API) to thereby interrogate one or more of one or more different hydrocarbon reservoir simulation response surface model proxies, the one or more different hydrocarbon reservoir simulation response surface model proxies to thereby define surface model proxies, the surface model proxies having a common image format based on a conversion from a plurality of different simulation model technology formats to the common image format, each of the surface model proxies being associated with one of one or more hydrocarbon reservoir simulation models, the proxy API configured to include a plurality of different preselected operations;
interpreting each of the one or more of the surface model proxies to thereby retrieve a simulation data set for each of the one or more of the surface model proxies responsive to each of the plurality of different preselected operations of the proxy API; and
displaying, for each of the one or more of the surface model proxies, one or more results of each of the plurality of different preselected operations of the proxy API to thereby probe the associated hydrocarbon reservoir simulation models.

10. A computer-implemented method as defined in claim 9, wherein displaying includes selectively displaying one or more uncertainty characteristics of each of the one or more of the surface model proxies by use of the proxy API, the one or more uncertainty characteristics configured to include an S-curve related to each of the surface model proxies, and wherein each of the one or more S-curves depicts cumulative probabilities of simulation outcome data.

11. A computer-implemented method as defined in claim 10, wherein each of the one or more S-curves includes a statistically most likely point and an output value of the related one of the surface model proxies for a preselected set of hydrocarbon reservoir simulation run parameters with respect to the surface model proxies.

12. A computer-implemented method as defined in claim 11, wherein one or more of the plurality of different preselected operations of the proxy API responsively enhance one or more workflows for hydrocarbon field development plans.

13. A computer-implemented method as defined in claim 12, wherein one or more third-party tools implement the one or more workflows for hydrocarbon reservoir field development plans.

14. A computer-implemented method as defined in claim 9, wherein the plurality of different preselected operations of the proxy API include each of:
determining, responsive to a first preselected simulation objective, an output value of one or more of the surface model proxies for a first preselected set of hydrocarbon reservoir simulation run parameters with respect to the surface model proxies to thereby query the one or more of the surface model proxies;
identifying, responsive to a second preselected simulation objective, one of the hydrocarbon reservoir simulation models associated with one of the surface model proxies when the one of the surface model proxies has an output value for a second preselected set of hydrocarbon reservoir simulation run parameters with respect to the surface model proxies that is closest to output values of a preselected simulation scenario to thereby define a closest model;
identifying, responsive to a third preselected simulation objective, two of the hydrocarbon reservoir simulation models each associated with one of the surface model proxies when one of the two of the surface model proxies has an output value for a third preselected set of hydrocarbon reservoir simulation run parameters with respect to the surface model proxies that is closest to the output value of another preselected simulated scenario among output values higher than the output value of the other preselected simulated scenario and when the other of the two of the surface model proxies has an output value for the third preselected set of hydrocarbon reservoir simulation run parameters that is closest to the output value of the other preselected simulated scenario among output values lower than the output value of the other preselected simulated scenario, the two hydrocarbon reservoir simulation models thereby defining close realization bracketing models; and
identifying names of one or more hydrocarbon reservoir simulation run parameters with respect to the surface model proxies responsive to a fourth preselected simulation objective to thereby return the identified one or more hydrocarbon reservoir simulation run parameters.

15. A computer-implemented method as defined in claim 9, wherein the proxy API relates to an environment for statistical computing that includes R programming language, wherein the common image format includes R image format, and wherein interpreting each of the one or more of the surface model proxies includes translating one or more R image files associated with each of the one or more of the surface model proxies into a format readable by the proxy API to thereby retrieve predetermined data from the one or more of the surface model proxies responsive to user request.

16. A computer-implemented method as defined in claim 9, wherein each of the plurality of different simulation model technology formats is associated with a unique set of one or more algorithms used to create a hydrocarbon reservoir simulation response surface model proxy and with a unique technology vendor, and wherein each of the one or more of the surface model proxies is configured to simulate performance for a respective preselected period of desired time.

17. Non-transitory computer-readable medium having one or more computer programs stored therein operable by one or more processors to enhance probing of hydrocarbon reservoir simulation models, the one or more computer programs comprising a set of instructions that, when executed by the one or more processors, cause the one or more processors to perform the operations of:
initiating a proxy application programming interface (API) to thereby interrogate one or more of one or more different hydrocarbon reservoir simulation response surface model proxies, the one or more different hydrocarbon reservoir simulation response surface model proxies to thereby define surface model proxies, the surface model proxies having a common image format based on a conversion from a plurality of different simulation model technology formats to the common image format, each of the surface model proxies being associated with one of one or more hydrocarbon reservoir simulation models, the proxy API configured to include a plurality of different preselected operations;
interpreting each of the one or more of the surface model proxies to thereby retrieve a simulation data set for each of the one or more of the surface model proxies responsive to each of the plurality of different preselected operations of the proxy API; and
displaying, for each of the one or more of the surface model proxies, one or more results of each of the plurality of different preselected operations of the proxy API to thereby probe the associated hydrocarbon reservoir simulation models.

18. Non-transitory computer-readable medium having one or more computer programs stored therein of claim 17, wherein displaying includes selectively displaying one or more uncertainty characteristics of each of the one or more of the surface model proxies by use of the proxy API, the one or more uncertainty characteristics configured to include an S-curve related to each of the surface model proxies, and wherein each of the one or more S-curves depicts cumulative probabilities of simulation outcome data.

19. Non-transitory computer-readable medium having one or more computer programs stored therein of claim 18, wherein each of the one or more S-curves includes a statistically most likely point and an output value of the related one of the surface model proxies for a preselected set of hydrocarbon reservoir simulation run parameters with respect to the surface model proxies.

20. Non-transitory computer-readable medium having one or more computer programs stored therein of claim 19, wherein one or more of the plurality of different preselected operations of the proxy API responsively enhance one or more workflows for hydrocarbon reservoir field development plans.

21. Non-transitory computer-readable medium having one or more computer programs stored therein of claim 20, wherein one or more third-party tools implement the one or more workflows for hydrocarbon reservoir field development plans.

22. Non-transitory computer-readable medium having one or more computer programs stored therein of claim 17, wherein the plurality of different preselected operations of the proxy API include each of:
determining, responsive to a first preselected simulation objective, an output value of one or more of the surface model proxies for a first preselected set of hydrocarbon reservoir simulation run parameters with respect to the surface model proxies to thereby query the one or more of the surface model proxies;
identifying, responsive to a second preselected simulation objective, one of the hydrocarbon reservoir simulation models associated with one of the surface model proxies when the one of the surface model proxies has an output value for a second preselected set of hydrocarbon reservoir simulation run parameters with respect to the surface model proxies that is closest to output values of a preselected simulation scenario to thereby define a closest model;
identifying, responsive to a third preselected simulation objective, two of the hydrocarbon reservoir simulation models each associated with one of the surface model proxies when one of the two of the surface model proxies has an output value for a third preselected set of hydrocarbon reservoir simulation run parameters with respect to the surface model proxies that is closest to the output value of another preselected simulated scenario among output values higher than the output value of the other preselected simulated scenario and when the other of the two of the surface model proxies has an output value for the third preselected set of hydrocarbon reservoir simulation run parameters that is closest to the output value of the other preselected simulated scenario among output values lower than the output value of the other preselected simulated scenario, the two hydrocarbon reservoir simulation models thereby defining close realization bracketing models; and
identifying names of one or more hydrocarbon reservoir simulation run parameters with respect to the surface model proxies responsive to a fourth preselected simulation objective to thereby return the identified one or more hydrocarbon reservoir simulation run parameters.

23. Non-transitory computer-readable medium having one or more computer programs stored therein of claim 17, wherein the proxy API relates to an environment for statistical computing that includes R programming language, wherein the common image format includes R image format, and wherein interpreting each of the one or more of the surface model proxies includes translating one or more R image files associated with each of the one or more of the surface model proxies into a format readable by the proxy API to thereby retrieve predetermined data from the one or more of the surface model proxies responsive to user request.

24. Non-transitory computer-readable medium having one or more computer programs stored therein of claim 17, wherein each of the plurality of different simulation model technology formats is associated with a unique set of one or more algorithms used to create a hydrocarbon reservoir simulation response surface model proxy and with a unique technology vendor, and wherein each of the one or more of the surface model proxies is configured to simulate performance for a respective preselected period of desired time.
